(19) United States
(12) Patent Application Publication
(10) Pub. No.: US 2009/0091122 A1
(43) Pub. Date: Apr. 9, 2009

(54) PERSONAL INFORMATION PROTECTING SHEET, METHOD OF MANUFACTURING THE SAME, AND ENVELOPE WITH PERSONAL INFORMATION PROTECTING SHEET

(76) Inventors: Toru Ogawa, Tokyo (JP); Masayoshi Kajiyama, Tokyo (JP); Toyonari Watanabe, Tokyo (JP); Takuji Oikawa, Tokyo (JP); Sakae Shirasawa, Tokyo (JP); Ryuichi Iwaoka, Tokyo (JP); Hiroyuki Yamaguchi, Tokyo (JP); Sunao Tada, Tokyo (JP); Yosuke Hirooka, Tokyo (JP); Kakuei Hoshino, Tokyo (JP); Akira Kayukawa, Tokyo (JP); Masami Matsumoto, Tokyo (JP); Satoru Terada, Tokyo (JP); Hiroshige Mochida, Tokyo (JP); Masamichi Onda, Tokyo (JP); Atsushi Rakuyama, Tokyo (JP); Kenji Sugaya, Tokyo (JP); Kiyotaka Shingu, Tokyo (JP); Koichi Kashiwabara, Tokyo (JP); Ryuichi Oshio, Tokyo (JP); Akira Kojima, Tokyo (JP); Makoto Hoken, Tokyo (JP); Yoshiyuki Kamata, Tokyo (JP); Yukihiro Matoi, Tokyo (JP); Masashi Miyabe, Tokyo (JP)

Correspondence Address: GREENBLUM & BERNSTEIN, P.L.C., 1950 ROLAND CLARKE PLACE, RESTON, VA, 20191, US

(21) Appl. No.: 11/719,630

(22) PCT Filed: Mar. 9, 2006
(86) PCT No.: PCT/JP2006/304643

§ 371 Date: May 17, 2007

(30) Foreign Application Priority Data
Mar. 11, 2005 (JP) 2005-070027
Mar. 11, 2005 (JP) 2005-070039
Dec. 26, 2005 (JP) 2005-372377
Dec. 26, 2005 (JP) 2005-372442
Feb. 17, 2006 (JP) 2006-041148
Feb. 17, 2006 (JP) 2006-041177
Feb. 17, 2006 (JP) 2006-041204
Feb. 17, 2006 (JP) 2006-041235
Feb. 17, 2006 (JP) 2006-041256
Feb. 17, 2006 (JP) 2006-041295
Feb. 17, 2006 (JP) 2006-041328
Feb. 17, 2006 (JP) 2006-041343
Feb. 17, 2006 (JP) 2006-041356
Feb. 17, 2006 (JP) 2006-041368
Feb. 17, 2006 (JP) 2006-041381

(51) Int. Cl. B42D 15/02

(52) U.S. Cl. 283/102

(57) ABSTRACT

The present invention provides a personal information protecting sheet in which personal information can be easily made illegible. The personal information protecting sheet includes a base material, a release layer formed on at least a part of the surface of the base material, and an image-receiving layer formed on the release layer. When a force having a directional component that is larger than a predetermined value and parallel to the surface of the base material is applied to the surface, a portion of the image-receiving layer to which the force is applied is peeled from the release layer.

### TECHNICAL FIELD

The present invention relates to a personal information protecting sheet in which personal information can be peeled and removed, a method of manufacturing the sheet, and an envelope with the personal information protecting sheet.

### BACKGROUND ART

When a mail on which personal information such as address or name is written is destroyed, there has been a problem that a portion on which personal information is written or the entire mail should be cut into small pieces with hands or cut by a scissors or shredder to prevent the personal information from leaking from the destroyed mail. In particular, it is very troublesome to cuts the mail into small pieces manually (with hands or a scissors) so that personal information cannot be specified.

In addition, a mail may include a bag made of a resin film to which a destination label (a label on which destination address and recipient's name are written) is adhered. In the case of this kind of mail, it is not possible to cut the destination label of the resin film into small pieces manually. For this reason, the destination label should be peeled from the resin film. However, since troubles arise if a destination label peels off during a delivery, it is common that the destination label is firmly adhered to the resin film. Accordingly, it is not easy to peel the destination label film from the bag made of a resin film.

In order to solve the above-mentioned problem, according to the invention disclosed in Patent Document 1, perforated lines, which are used to separate an information writing region from a paper, are formed at the peripheral portion of the information writing region. Further, cutting lines, which are used to cut the information writing region into a plurality of small pieces, are formed in the paper. Accordingly, the information writing region is separated from the paper and is cut along the cutting lines. As a result, it is possible to cut the information writing region into small pieces.

A “label on which personal information is shown” disclosed in Patent Document 2 has been proposed to solve the above-mentioned problem. According to the invention disclosed in Patent Document 2, slits are provided to divide a personal information region into several portions.

Patent Document 1: Japanese Patent Application Laid-Open No. 2004-317875

Patent Document 2: Japanese Patent Application Laid-Open No. 2001-175175

### DISCLOSURE OF THE INVENTION

### Problems to be Solved by the Invention

However, according to the invention disclosed in Patent Document 1, it is difficult to separate the information writing region from the paper (the information writing region could not be separated along the perforated lines), and there has been an undesirable possibility that other portions of paper are damaged. In addition, it is not particularly different from the conventional operation of cutting a personal information label with scissors or by hand to cut the information writing region into small pieces along the cutting lines so that personal information cannot be specified. Accordingly, the operation is also troublesome.

According to the invention disclosed in Patent Document 2, the base material of the label on which personal information is written should peel off to make personal information illegible. However, if the base material of the label is designed to easily peel off, the base material of the label could peel off by mistake. If the base material of the label is designed to adhere firmly, it is difficult to peel off the base material while making personal information illegible.

Further, according to the invention disclosed in Patent Document 2, information printed on the label remains on the cut pieces. Accordingly, if the cut pieces are put together, personal information can be restored.

In addition, even in the case of the structure in which the label can be cut into small pieces, a user performs the cutting operation by oneself (if it is a mail, a recipient performs it). For this reason, if a user does not pay much attention to the handling of personal information, the user does not cut the label cautiously into small pieces for personal information not to be specified. On occasion, the cutting of the label is insufficient and then the label is destroyed.

In view of the foregoing, it is an objective of the present invention to provide a personal information protecting sheet in which personal information can be easily made illegible, a method of manufacturing the personal information protecting sheet, and an envelope with the personal information protecting sheet.

### Means for Solving the Problems

In order to achieve the above-mentioned objective, there is provided a personal information protecting sheet that includes a base material, a release layer formed on at least a part of the surface of the base material, and an image-receiving layer formed on the release layer.

In the above-mentioned structure, an information indicating part that indicates information relating to a specified person may be formed on the image-receiving layer. Alternatively, the release layer may be formed to have the shape of a predetermined pattern. In addition, an information indicating part, which indicates information relating to a specified person, may be formed so that at least a part of the information indicating part is formed on the image-receiving layer.

Further, according to a second aspect of the present invention, a personal information protecting sheet includes a base material, a confidential information part formed on one surface of the base material, a release layer formed on at least a part of the base material so as to cover the confidential information part, and an opaque image-receiving layer formed on the release layer.

In the structure, an information indicating part that indicates information relating to a specified person may be formed on the image-receiving layer. In addition, information indicated by the confidential information part may be related to information indicated by the information indicating part.

In the structure including the information indicating part according to the first or second aspect of the present invention, at least one personal information unprinted region, on which the information indicating part is not formed, may be formed on the image-receiving layer. In addition, the personal information unprinted region may be formed at the peripheral portion of the image-receiving layer. Further, the personal information unprinted region may have a shape including a 1 cm×1 cm square. Furthermore, information relating to the information indicated by the information indicating part may be indicated on the base material in a region in which the release layer is not formed. In addition, the information relating to the information indicated by the information indicating part may be encoded. Further, at least the image-receiving layer may be formed only on a region having substantially the same shape as a region occupied by the information indicating part.

Any one of the structures, which include the information indicating part, according to the first and second aspects of the present invention, may further include an attention attracting part for indicating that the image-receiving layer can be peeled from the release layer. In addition, the attention attracting part may be formed in a region in which the release layer is not formed.

In any one of the structures including the information indicating part according to the first and second aspects of the present invention, the image-receiving layer may have color different from the base material.

Any one of the structures, which include the information indicating part, according to the first and second aspects of the present invention may further include an adhesive layer formed on a surface opposite to the surface, on which layers are formed, of the base material. In addition, the adhesive strength between the adhesive layer and an adhesion object may be higher than the adhesive strength between the release layer and the image-receiving layer.

According to a third aspect of the present invention, a personal information protecting sheet includes a base material, and a release layer that is formed on at least a part of the surface of the base material and is peeled from an information indicating part. In this case, the information indicating part is formed on the release layer and indicating information relating to a specified person.

In the structure, information, which indicates the information relating to a specified person, may be indicated by the information indicating part. Alternatively, the release layer may be formed to have the shape of a predetermined pattern. In addition, an information indicating part, which indicates information relating to a specified person, may be formed so that at least a part of the information indicating part is formed on the release layer.

In the structure including the information indicating part, at least one personal information unprinted region, on which the information indicating part is not formed, may be formed on the release layer. In addition, the personal information unprinted region may be formed at the peripheral portion of the release layer. Further, the personal information unprinted region may have a shape including a 1 cm×1 cm square.

In the structure including the information indicating part, information relating to the information indicated by the information indicating part may be indicated on the base material in a region in which the release layer is not formed. In addition, the information relating to the information indicated by the information indicating part may be encoded.

Even in any one of the structures including the information indicating part, the release layer may be formed only on a region having substantially the same shape as a region occupied by the information indicating part. Further, any one of the structures may further include an attention attracting part for indicating that the information indicating part can be peeled from the release layer. The attention attracting part may be formed on the base material in a region in which the release layer is not formed.

Even in any one of the structures, the release layer may have color different from the base material. Further, any one of the structures may further include an adhesive layer formed on a surface opposite to the surface, on which the release layer is formed, of the base material.

In the structure including the adhesive layer, the adhesive strength between the adhesive layer and an adhesion object may be higher than the adhesive strength between the release layer and the information indicating part formed on the release layer.

Even in any one of the structures including the adhesive layer according to the first, second, and third aspects of the present invention, the base material may be made of paper having a basis weight of 30 g/m² or more. Further, incisions may be formed in the base material.

Any one of the structures, which include the information indicating part, according to the first, second, and third aspects of the present invention may further include a protective layer, which is made of a transparent material, formed on the top. Any one of the structures according to the first, second, and third aspects of the present invention may further include a layer having a cushioning property between the release layer and the base material. Alternatively, the base material may have a cushioning property. Further, the release layer may be formed to have a thickness, which is equal to or larger than a thickness corresponding to an arithmetic mean roughness on the surface of the base material.

According to a fourth aspect of the present invention, an envelope with a personal information protecting sheet includes a personal information protecting sheet according to any one of the first, second, and third aspects of the present invention, a receiving bag for receiving the personal information protecting sheet. In this case, a position of the receiving bag corresponding to at least the information indicating part may be formed to be transparent or translucent.

In the structure, the receiving bag may include a transparent or translucent window at a position corresponding to the information indicating part.

Further, according to a fifth aspect of the present invention, a method of manufacturing a personal information protecting sheet includes forming an information indicating part on an image-receiving layer by a nonimpact printing method. The information indicating part indicates information relating to a specified person. A base material, a release layer on at least a part of one surface of the base material, and the image-receiving layer on the release layer form stacked layers.

Further, according to a sixth aspect of the present invention, a method of manufacturing a personal information protecting sheet includes a step of forming on a release layer by a nonimpact printing method an information indicating part that indicates information relating to a specified person. The release layer is formed on at least a part of one surface of a base material. The release layer and the base material form stacked layers.

### EFFECTS OF THE INVENTION

According to the present invention, it is possible to provide a personal information protecting sheet in which personal information can be easily made illegible, a method of manufacturing the personal information protecting sheet, and an envelope with the personal information protecting sheet.

### BEST MODE FOR CARRYING OUT THE INVENTION

First, exemplary embodiments will be schematically described with reference to FIG. 1.

A personal information protecting sheet includes a base material 10, a release layer 20 that is a surface inactive radiation curing resin layer, and a image-receiving layer 30 that is a resin layer having a small cohesive force. The layer 20 and the layer 30 are sequentially built up on the base material 10. The image-receiving layer 30 has a small adherence to the release layer 20. When a force substantially parallel to the base material is locally applied to the image-receiving layer 30 (when the image-receiving layer is scrubbed with a coin or nail), the image-receiving layer 30 is peeled from an interface between the image-receiving layer 30 and the release layer 20. An information indicating part 40 is formed on the image-receiving layer 30 by means of a known printing method (with a printer using ink or toner, printing, or handwriting with a pencil, or the like) and provides personal information (address, name, or phone number). When the surface of the image-receiving layer 30 is scrubbed with a coin or nail, the image-receiving layer 30 is peeled off along with the personal information (information indicating part 40) formed on the surface of the image-receiving layer 30. Accordingly, personal information does not leak from the destroyed mail.

Further, as shown in FIG. 11, the personal information protecting sheet may not include the image-receiving layer (the surface inactive radiation curing resin layer used as a release layer 20 may be formed on the base material 10). An information indicating part 40 is formed on the release layer 20 by means of a known printing method (a printer using ink or toner, printing, or handwriting with a pencil, or the like) and provides personal information (address, name, or phone number). When the release layer 20 is scrubbed with a coin or nail, the personal information (information indicating part 40) formed on the surface of the release layer 20 is peeled off. Accordingly, the information indicating part 40 for indicating personal information is peeled away when an envelope or a postcard (the base material) is destroyed, and it is possible to prevent the leak of the personal information.

In the following description, the information indicating part 40 for indicating personal information is formed on the release layer 20 or the image-receiving layer 30, but the information indicating part 40 may be left blank. In this case, a user may form the information indicating part 40 on the personal information protecting sheet by using a known printing method to show arbitrary information.

### FIRST EMBODIMENT

Hereinafter, a first embodiment will be described with reference to accompanying drawings.

FIG. 1 is a cross-sectional view of a personal information protecting sheet.

As shown in FIG. 1, a personal information protecting sheet includes an image-receiving layer 30, a release layer 20, and a base material 10. The base material is, for example, a paper, an envelope, a postcard, or a label board. The release layer 20 and the image-receiving layer 30 are sequentially built up on the base material 10. Personal information is shown on the image-receiving layer 30 by an information indicating part 40, which is formed on the image-receiving layer 30 by a known printing method. The release layer 20 and the image-receiving layer 30 are formed on the base material 10 by a method such as offset printing, gravure printing, or flexographic printing. However, if these layers do not need to have a particularly large thickness, the offset printing or the flexographic printing is suitable to form the layers in consideration of cost.

### [Base Material]

The base material 10 may be made of a material appropriately selected from known materials. For example, paper (woodfree paper, coated paper, kraft paper, and the like), a polyester film (polyethylene terephthalate, polyethylene terephthalate-isophthalate copolymer, and the like), a polyolefin film (polyethylene, polypropylene, polymethylpentene, and the like), a plastic film (a polyvinyl chloride film, an ethylene-vinylalcohol copolymer film, a polycarbonate film, a polyamide film, and the like), synthetic paper made of polyolefin, and the like may be used as the base material.

In addition, an adhesive layer 70 is provided on the lower surface of the base material 10 if necessary and the personal information protecting sheet can be adhered to other media (envelope and the like). In this case, if release coated paper is provided on the lower surface of the adhesive layer to form layers (the image-receiving layer/the release layer/the base material/the adhesive layer/the release paper), the personal information protecting sheet can be used as a label. When the personal information protecting sheet is used as a label, it is preferable that incisions 10a be formed in the base material 10 as shown in FIG. 2 to reduce the mechanical strength of the personal information protecting sheet (to be brittle). Once these incisions are formed in the base material, the personal information protecting sheet is torn due to the incisions 10a even if someone tries to peel off the entire personal information protecting sheet adhered to an adhesion object. Accordingly, the personal information does not leak because the personal information protecting sheet is not peeled or taken away.

Further, when the personal information protecting sheet includes the adhesive layer 70 and is used as a personal information protecting label, if the strength of the base material 10 is low, there is a possibility that the base material 10 is damaged during the scrubbing of the image-receiving layer 30 with a coin or nail. When the base material 10 is damaged, the pieces of the information indicating part 40 remain in the same shape as the damaged base material. Accordingly, when the pieces are put together, it is possible to restore the personal information. In particular, when the personal information protecting label is used as a mailing label and adhered to a mail, mails come in contact with each other and thus the base material 10 may be damaged. For this reason, personal information shown in the information indicating part 40 becomes illegible, thereby causing mail troubles.

Accordingly, when the personal information protecting sheet includes the adhesive layer 70 and is used as a personal information protecting label, it is preferable that paper having a basis weight of 30 g/m² or more be used as the material of the base material 10.

### [Release Layer]

An ultraviolet curing resin, such as urethane acrylate or epoxy acrylate, or an electron beam curing resin is used as the material of the release layer 20. Further, a solvent type thermoplastic resin (a vinyl chloride-vinyl acetate copolymer resin, an acrylic acid ester-styrene copolymer resin, nitrocellulose, a maleic acid resin, and the like), a water-soluble resin (polyvinyl alcohol, polyvinylpyrrolidone, and the like), various acrylic copolymer resins, or polyurethane may be independently used as the material of the release layer. Alternatively, each of them may be used together with a release agent, such as a silicon resin, as the material of the release layer.

Further, the composition of a mixture used as base materials of the release layer 20 is shown in Table 1. The ratio of various materials may be appropriately changed as long as the sum of the ratio of various materials is 100%.

In addition, a purpose to use each of the materials is as follows:

A monomer is used as a reactive diluent, and functions to control the viscosity of the mixture. Synthetic resins are used as a main part of a resin component for forming the release layer 20. An initiating reagent facilitates the curing (drying) reaction of the mixture. A release agent allows the release layer 20 to have peelability. A color pigment is used to color the release layer 20.

TABLE 1
Release layer

| Chemical name or general name | Percentage |
|---|---|
| Monomer | 50-60% |
| Synthetic resins | 30-40% |
| Initiating reagent | 5-15% |
| Release agent | Less than 5% |
| Color pigment | 0-20% |

Monomer: urethane acrylate, epoxy acrylate, or the like.
Synthetic resins: urethane acrylate resin, epoxy acrylate resin, or the
like.
Initiating reagent: benzoin methyl ether, benzophenone, or the like.
Release agent: polydimethyloxy acid, polyethylene wax, or the like.
Color pigment: phthalocyanic pigment, titanium oxide, lake red c, or the
like.

### [Image-Receiving Layer]

An ultraviolet curing resin or the like is used as the image-receiving layer 30. The composition of a mixture used as base materials of the image-receiving layer 30 is shown in Table 2. The percentage of various materials may be appropriately changed as long as the sum of the percentage of various materials is 100%.

In addition, a purpose to use each of the materials is as follows:

A pigment has the properties of an extender pigment and a color pigment. The extender pigment has a property that allows binder materials to have thixotropy (a property in which viscosity decreases when stress is applied). Further, the color pigment has a property that allows binder materials to be colored. Titanium white may be used as an example of the color pigment. A monomer is used as a reactive diluent, and controls the viscosity of the mixture. Synthetic resins are used as a main part of a resin component for forming the image-receiving layer. An initiating reagent facilitates the curing (drying) reaction of the mixture. Further, a release agent may be contained in the mixture used as a main part of the image-receiving layer 30. If the release agent is contained in the mixture, peelability (how easily the image-receiving layer is peeled from the release layer 20) is improved.

TABLE 2
Image-receiving layer

| Chemical name or general name | Percentage |
|---|---|
| Pigment | 10-60% |
| Monomer | 5-20% |
| Synthetic resins | 15-65% |
| Initiating reagent | 2-5% |

Pigment: calcium carbonate, aluminum oxide, silicon oxide, barium oxide,
titanium oxide, or the like.
Monomer: urethane acrylate, epoxy acrylate, or the like.
Synthetic resins: urethane acrylate resin, epoxy acrylate resin, or the
like.
Initiating reagent: benzoin methyl ether, benzophenone, or the like.

In addition, it is preferable that the image-receiving layer 30 be colored to have color different from the base material 10 and thus a layer other than the base material 10 is visually confirmed.

The mixture used as a material of the image-receiving layer 30 may contain a pigment having color different from the base material 10 in order to color the image-receiving layer 30 with color different from the base material 10. In this case, it is generally preferable that the image-receiving layer 30 have color (red or yellow color) attracting one's attention. Further, if the color of the image-receiving layer is different from that of the base material 10 even though a pigment is not added to the image-receiving layer, the image-receiving layer 30 does not need to contain a pigment.

The release layer 20 and the image-receiving layer 30 were formed using offset printing. Table 3 shows test results of printability, peelability, and frictional resistance when the release layer 20 has a predetermined thickness and the image-receiving layer 30 is formed to have a thickness of 0.4, 0.7, 1.1, or 1.7 μm. In addition, woodfree paper was used as the base material 10.

When woodfree paper is used as the base material 10, the printability of the image-receiving layer 30 was excellent even if the image-receiving layer 30 has a thickness of 0.4, 0.7, 1.1, or 1.7 μm. That is, the printability does not depend on the thickness of the image-receiving layer 30. Next, peelability was tested by scrubbing the image-receiving layer with a coin or nail. The peelability was excellent only when the thickness of the image-receiving layer 30 was 1.1 or 1.7 μm. That is, the image-receiving layer 30 needs to have a certain thickness to be peeled from the release layer 20. Next, when the thickness of the image-receiving layer 30 was 0.4, 1.1, or 1.7 μm, frictional resistance was excellent. That is, when the image-receiving layer is thicker, the frictional resistance is better. However, even though the image-receiving layer is excessively thin, the frictional resistance of the image-receiving layer is excellent due to the influence of the base material 10.

Considering both peelability and frictional resistance, it was preferable that the image-receiving layer 30 have a thickness of 1.1 or 1.7 μm in the present embodiment (when woodfree paper is used as the base material 10).

TABLE 3

| | Thickness of | Test item | | |
|---|---|---|---|---|
| Type of | image-receiving | | | Frictional |
| papaer | layer (μm) | Printability | Peelability | resistance |
| Woodfree | 0.4 | ◯ | x | ◯ |
| paper | 0.7 | ◯ | Δ | Δ |
| | 1.1 | ◯ | ◯ | ◯ |
| | 1.7 | ◯ | ◯ | ◯ |

◯: very good, Δ: good, x: bad

Further, when the personal information protecting sheet is used as a postcard, an envelope such as a paper envelope or a film envelope, or a label board, unnecessary friction may be applied to a part of the sheet during the mailing. However, even though the unnecessary friction is applied to the image-receiving layer 30 and the information indicating part 40, the image-receiving layer 30 and the information indicating part 40 need to have frictional resistance so that the release layer 20 is not peeled away by accident.

FIG. 3 is a view showing that the image-receiving layer 30 is scratched off from the release layer 20.

As shown in FIG. 3, the image-receiving layer 30 and the information indicating part 40 formed on the image-receiving layer 30 are simultaneously peeled and removed from the release layer 20 by scratching the image-receiving layer with a coin or nail (in other words, by scrubbing the image-receiving layer 30 while a pressure larger than a predetermined pressure is applied to the image-receiving layer). Further, the adherence between the image-receiving layer 30 and the release layer 20 can be controlled by the composition of mixtures for the release layer 20 and the image-receiving layer 30.

In general, as shown in FIG. 4(a), personal information such as an address and a name occupies only part of a postcard, an envelope, and a label board. The areas corresponding to the address and the name are scratched as shown in FIG. 4(b). Accordingly, since the entire image-receiving layer 30 need not be scratched like a so-called conventional “scratch card”, it is possible to minimize an amount of wastes.

Further, when the image-receiving layer 30 is formed using flexographic printing, it is possible to form the image-receiving layer with ink having composition different from the composition of the mixture shown in Table 2.

Table 4 shows the composition of a mixture used for the image-receiving layer 30 when the image-receiving layer 30 is formed using flexographic printing. A binder resin is a resin used as a main ingredient of the image-receiving layer 30 after drying. An extender pigment allows the image-receiving layer 30 to have thixotropy (a property in which viscosity decreases when stress is applied). A mat agent is added to allow the surface of the image-receiving layer 30 to have predetermined roughness. The viscosity of the flexographic ink is changed depending on the amount of water. Color pigments are added to color the image-receiving layer 30.

TABLE 4
Flexographic ink

| General name | Percentage |
|---|---|
| Binder resin | 15-30% |
| Extender pigment | 5-10% |
| Mat agent | 3-5% |
| Water | 40-70% |
| Color pigment | 5-20% |

Binder resin: Water-based emulsion with acryl-based and
urethane-based resins.
Extender pigment: Calcium oxide or the like.
Mat agent: Silicon dioxide, or the like.
Color pigment: phthalocyanine-based pigment, or the like.

If the image-receiving layer 30 is formed using the flexographic ink to have a larger thickness (about 10 μm) as compared to when the image-receiving layer 30 is formed using offset printing, the thickness of the image-receiving layer coming in contact with a coin or nail is increased (in other words, a coin or nail applies a large force to the image-receiving layer 30 in a lateral direction). For this reason, it is easy to peel the image-receiving layer 30 from the release layer 20.

Further, although the information indicating part 40 can have been formed using an arbitrary printing method, it is preferable that the information indicating part be formed using a nonimpact printing method (noncontact method, that is, a printing method using a so-called inkjet printer, thermal transfer printer, laser printer, or the like).

If the information indicating part is formed using an impact printing method as shown in FIG. 5(a), printing impressions 130 still remain after the image-receiving layer 30 is scrubbed and peeled away. Accordingly, if one moves a pencil lightly back and forth over the printing impressions 130, characters, letters or marks will show up and the personal information will be obtained.

In contrast, the information indicating part 40 is formed using a nonimpact printing method in the present invention. For this reason, as shown in FIG. 5(b), printing impressions do not remain after the image-receiving layer 30 is scrubbed and peeled off. Accordingly, it is not possible to restore personal information from printing impressions. As a result, there is no possibility that personal information is revealed from the personal information protecting sheet after the peeling of the image-receiving layer 30.

According to the personal information protecting sheet of the present embodiment, it is not possible to recognize by appearances that the image-receiving layer 30 can be peeled from the release layer 20. For this reason, as shown in FIG. 6, an attention attracting part 60 is preferably provided at an arbitrary position on the personal information protecting sheet to notify a user that the image-receiving layer 30 can be peeled from the release layer 20. However, if the attention attracting part is provided on the release layer 20, the portion corresponding to the attention attracting part may also be peeled off. For this reason, it is preferable that the attention attracting part (for indicating that the image-receiving layer 30 can be peeled from the release layer 20) be provided not on the release layer 20. If the release layer 20 or the image-receiving layer 30 is formed of color ink by printing, the attention attracting part may be simultaneously formed during the formation of the release layer 20 or the image-receiving layer 30. As a result, it is possible to indicate that the image-receiving layer 30 can be peeled from the release layer 20 without the increase of processes. Further, the attention attracting part may be simultaneously formed during the formation of the information indicating part 40. In addition, the style of the attention attracting part 60 is not limited to the above example as long as the attention attracting part can notify a user that the image-receiving layer 30 can be peeled off. Therefore, characters or designs (for example, drawings that show the scratching with a coin) may be adopted.

According to the personal information protecting sheet, which is formed as described above, even though the image-receiving layer 30 is lightly scrubbed (for example, even though the image-receiving layer is scrubbed with the tip of a finger or an eraser), the scrubbed portion is not peeled from the release layer 20. However, if the image-receiving layer is scrubbed while a pressure larger than a predetermined pressure is applied to the image-receiving layer (for example, if the image-receiving layer is scrubbed with a coin or nail), the scrubbed portion is peeled from the release layer 20.

Even though an adhesive tape is adhered to the image-receiving layer 30, force is not locally concentrated on the image-receiving layer 30 during the peeling of the adhesive tape. Accordingly, the image-receiving layer 30 is not peeled off. If an adhesive tape is adhered to the surface of a so-called conventional “scratch card” and is then peeled from the card, a concealing layer (a silver layer) is peeled off. Considering this, it is preferable that the adherence between the image-receiving layer 30 and the release layer 20 in the personal information protecting sheet be larger than the concealing layer of the conventional scratch card.

Accordingly, even though the personal information protecting sheet is applied to a mail, personal information is legible despite the scrubbing of the image-receiving layer 30. As a result, mails are not lost.

According to the personal information protecting sheet, if the image-receiving layer 30 is scrubbed while a pressure larger than a predetermined pressure is applied to the image-receiving layer, the image-receiving layer 30 is peeled and removed from the release layer 20. Accordingly, if personal information is indicated on the image-receiving layer 30 by the information indicating part 40, the image-receiving layer and the information indicating part are peeled and removed at the same time. For this reason, when the personal information protecting sheet on which personal information is indicated is destroyed, it is possible to make the personal information illegible with a simple operation and to prevent the personal information from being revealed from the destroyed sheet.

Further, the personal information protecting sheet may further include a cushion layer 160 as shown in FIG. 7(a).

The cushion layer 160 has a cushioning property (volume elasticity). For this reason, when the image-receiving layer 30 is scrubbed with a coin or nail, the image-receiving layer 30 and the release layer 20 are deformed to the shape of the coin or nail as shown in FIG. 8(a). Accordingly, a contact area between the coin or nail and the image-receiving layer 30 is increased as shown in FIG. 8(b). As a result, a larger area of the image-receiving layer 30 is scrubbed and removed at one time compared to when the personal information protecting sheet does not include the cushion layer 160.

The cushion layer 160 is formed between the release layer 20 and the base material 10 in the present embodiment. However, if other layers are provided between the base material 10 and the release layer 20, the cushion layer 160 may be provided at any position between the release layer 20 and the base material 10.

### [Cushion Layer]

The cushion layer 160 is made of a known resin material having a cushioning property (for example, a urethane resin film or polyamide resin film, a polyester resin film, a polyolefin resin film, a resin coating layer containing a foaming agent, or a resin sheet containing a foaming agent), a paper material (plain paper or coated paper), or the like.

Further, when being made of the resin material, the cushion layer has a thickness in the range of 10 to 450 μm. If the thickness of the cushion layer 160 is less than 10 μm when being made of the resin material, the cushion layer 160 is excessively thin and it is not possible to obtain a sufficient cushioning property. Meanwhile, if the thickness of the cushion layer 160 exceeds 450 μm, the layer is not soft enough. For this reason, there is a problem that a sufficient cushioning property is not obtained or manufacturing cost is increased. Further, since a non-stretch film has excellent flexibility, it is preferable that the non-stretch film be used as the cushion layer 160 even though being made of any resin material.

In addition, when the cushion layer is made of a paper material, a paper material having a basis weight in the range of 30 to 500 g/m² is used as the material of the cushion layer. If a paper material has a basis weight less than 30 g/m², paper is excessively thin. For this reason, it is not possible to obtain a sufficient cushioning property. Meanwhile, if a paper material has a basis weight exceeds 500 g/m², manufacturing cost of the cushion layer is increased. For this reason, although it is possible to obtain a cushioning property, it is not preferable in terms of practical use that the cushioning layer be made of the paper material having a basis weight exceeding 500 g/m².

Alternatively, as shown in FIG. 9(a), a base material 10′ may be made of a material having a cushioning property. In other words, the base material 10′ may have a cushioning property. A known resin material having a cushioning property (for example, a urethane resin film or polyamide resin film, a polyester resin film, a polyolefin resin film, a resin coating layer containing a foaming agent, or a resin sheet containing a foaming agent), a paper material (plain paper or coated paper), or the like may be used as the material of the base material 10′.

If the base material 10′ has a cushioning property, the image-receiving layer 30 is dented by the coin or nail due to the cushioning property of the base material 10′ when the image-receiving layer 30 is scrubbed with a coin or nail. Like when a cushion layer is separately provided, it is possible to scrub and remove the larger area of the image-receiving layer 30 at one time.

Alternatively, as shown in FIG. 10, a personal information protecting sheet may be enclosed in a window envelope (an envelop with a window) 140 having a window 150 that corresponds to an information indicating part 40 formed on an image-receiving layer 30 (or a release layer 20 when the personal information protecting sheet does not include the image-receiving layer).

The window 150 is formed by covering an opening of an envelope with a transparent film or translucent paper. The information indicating part 40 of the personal information protecting sheet enclosed in the envelope is visible through the window 150 without opening the envelope 100. Further, the window envelope 140 may have other shapes of a window as long as the information indicating part 40 formed on the image-receiving layer 30 (or the release layer 20) is visible through the window. Furthermore, the entire envelope may be made of transparent plastics.

If the information indicating part 40 indicates a destination (address or name) on the personal information protecting sheet according to the present embodiment and the personal information protecting sheet is enclosed in the envelope 100 to form a mail, personal information does not become legible due to the scrubbing of the image-receiving layer 30 during a delivery. As a result, mail accidents do not occur.

In addition, since the frictional resistance of the image-receiving layer 30 does not need to be considered during a delivery, it is easy to manage the adherence between the image-receiving layer 30 and the release layer 20. For this reason, it is possible to easily manufacture the personal information protecting sheet, thereby also improving productivity.

When the personal information protecting sheet does not include an image-receiving layer, as shown in FIG. 11, the personal information protecting sheet has a base material 10 (paper or an envelope, a postcard, and a label board) and a release layer 20 on which personal information is indicated. Personal information is indicated on the release layer 20 by an information indicating part 40, which is formed using a known printing method. The release layer 20 is formed on the base material 10 by a method such as offset printing, screen printing, gravure printing, or flexographic printing. However, if the release layer 20 does not need to have a particularly large thickness, the offset printing or the flexographic printing is suitable to form the release layer in view of cost.

A base material and a release layer are the same as described in [Base material] and [Release layer].

When the personal information protecting sheet has the above-mentioned structure, as shown in FIG. 12, the information indicating part 40 formed on the release layer 20 is peeled and removed from the release layer 20 by scratching the release layer 20 with a coin or nail (in other words, by scrubbing the release layer 20 while a pressure larger than a predetermined pressure is applied to the release layer). Further, the adherence between the release layer 20 and the information indicating part 40 can be controlled by the composition of a mixture used as main materials of the release layer 20.

In the case when the personal information protecting sheet does not include the image-receiving layer 30, if a color pigment is contained in the mixture used as materials of the release layer 20 to allow the release layer 20 to have color different from the base material 10, it is possible to visually confirm the formation of a layer other than the base material 10.

Further, if the cushion layer 160 is provided between the base material 10 and the release layer 20 as shown in FIG. 7(b), or if the base material 10′ has a cushioning property as shown in FIG. 9(b), the release layer 20 is dented by the coin or nail due to the cushioning property (resiliency or elasticity) when the release layer 20 is scrubbed with a coin or nail. In addition, it is possible to scrub and remove a large area of the image-release layer at one time.

### SECOND EMBODIMENT

A second preferred embodiment of the present invention will be described below.

A personal information protecting sheet according to the present embodiment has the same structure as the personal information protecting sheet of the first embodiment. A release layer 20 and an image-receiving layer 30 are sequentially built up on a base material 10, and personal information is shown on the image-receiving layer 30 by an information indicating part 40 that is formed on the image-receiving layer 30 by a known printing method.

However, the release layer 20 is formed on the base material 10 to have a thickness, which is equal to or larger than a thickness corresponding to the arithmetic mean roughness (Ra) on the surface of the base material 10.

Further, the arithmetic mean roughness (Ra) is obtained as follows: a portion of a roughness curve corresponding to reference length L in a mean line direction (X direction) is taken from the roughness curve, and absolute values of deviation (deviation in a Y direction) between a mean line of the taken portion and a measurement curve y=f(x) are summed and averaged. Then, the arithmetic mean roughness can be calculated by Equation 1. The arithmetic mean roughness (Ra) has a characteristic in which one defect has very little effect on a measured value and thus a reliable result is obtained.

$$\begin{matrix}[ Equation 1 ] & \\ Ra = \frac{1}{L} {\int }_{0}^{L} \vert f ( x ) \vert d x & ( 1 )\end{matrix}$$

Table 5 shows the arithmetic mean roughness on the surface of the base material 10, and an arithmetic mean roughness of the release layer 20 formed on the base material. In Table 4, the surface roughness of the woodfree paper is the surface roughness of a product called as “NPi foam55”, which is manufactured by Nippon Paper Industries Co. Ltd. Further, the surface roughness of “matt coated paper” is the surface roughness of a product called as “alpha mat”, which is manufactured by Hokuetsu Paper Mills, Ltd. Furthermore, the surface roughness of “gross coated paper” is the surface roughness of a product called as “full color foam(G)55”, which is manufactured by Nippon Paper Industries Co. Ltd.

TABLE 5

| | Arithmetic mean surface roughness |
|---|---|
| Sample | RA (μm) |
| Woodfree paper | 1.494 |
| Woodfree paper + Release layer | 1.29 |
| Mat coated paper | 0.599 |
| Mat coated paper + Release layer | 0.548 |
| Gross coated paper | 0.393 |
| Gross coated paper + Release layer | 0.586 |

Even though any material is used, there are concavities and convexities (for example, concavities and convexities caused by fibers when the base material 10 is paper) on the surface of the base material 10. However, the adherence between two layers of a built-up structure is increased as much as the surface roughness of the interface is high. Further, a release agent does need to be contained in a ground layer to peel off the image-receiving layer 30 when a force having a directional component that is larger than a predetermined value and parallel to the surface of the base material is applied to the surface.

For this reason, if the surface roughness of the release layer 20 is smaller than the surface roughness of the base material 10, it is possible to obtain leveling (planarization) effect by forming the release layer 20 as shown in FIG. 13(a) and to improve the peelability. However, even in this case, if the thickness of the release layer 20 is not sufficient, the convexities of the base material 10, which protrude from the release layer 20 as shown in FIG. 13(b), come in contact with the image-receiving layer 30. For this reason, the image-receiving layer 30 cannot have sufficient peelability.

According to the personal information protecting sheet of the present embodiment, the release layer 20 is formed to have a thickness, which is equal to or larger than a thickness corresponding to the arithmetic mean roughness of the base material 10. Accordingly, the convexities of the base material 10 hardly protrude from the release layer 20, and peelability between the release layer 20 and the image-receiving layer 30 is excellent.

For this reason, even though a material having surface roughness smaller than that of the release layer 20 (for example, gross coated paper) is used as the base material 10, if the personal information protecting sheet does not include the release layer 20 containing a release agent, the image-receiving layer 30 cannot have peelability.

In this case, the surface roughness after the formation of the release layer 20 is larger than the surface roughness of the base material. However, even in this case, the image-receiving layer 30 can easily have peelability where the image-receiving layer is peeled from the release layer 20. In addition, according to the present embodiment, if the arithmetic mean roughness after the formation of the release layer 20 is in the range of 0.5 to 0.6 μm, it is possible to obtain excellent peelability.

Like in the first embodiment, even in the personal information protecting sheet according to the present embodiment, it is preferable to indicate that the image-receiving layer 30 can be peeled from the release layer 20 at an arbitrary position on the personal information protecting sheet. In this case, if an index where the image-receiving layer 30 can be peeled from the release layer 20 is provided not on the release layer 20 but on a region where the release layer 20 is not formed, there is no possibility that the index is removed. Accordingly, it goes without saying that the index provided as described above is preferable.

Like in the first embodiment, according to the personal information protecting sheet of the present embodiment, the image-receiving layer 30 is peeled and removed from the release layer 20 by scrubbing the image-receiving layer 30 while a pressure larger than a predetermined pressure is applied to the image-receiving layer. Accordingly, if personal information is indicated by the information indicating part 40 formed on the image-receiving layer 30, the image-receiving layer and the information indicating part are peeled and removed at the same time. As a result, when the personal information protecting sheet on which personal information is indicated is destroyed, it is possible to make the personal information illegible with a simple operation and to prevent the personal information from being revealed from the destroyed sheet.

Further, even though the release layer 20 is formed to have a thickness that is equal to or larger than a thickness corresponding to the arithmetic mean roughness (Ra) on the surface of the base material 10, in the personal information protecting sheet that has the layer structure shown in FIG. 11, it is possible to make the personal information illegible and to prevent the leak of the personal information.

### THIRD EMBODIMENT

A third preferred embodiment will be described below. FIG. 14 shows the structure of the personal information protecting sheet according to the present embodiment. The personal information protecting sheet has the same structure as the personal information protecting sheet according to the first embodiment except that a protective layer 50 is formed on an information indicating part 40. The protective layer 50 is transparent, and personal information indicated by the information indicating part 40 is visible.

The protective layer 50 is formed by adhering a plastic film or by printing or applying a water-soluble resin or a waterproof resin. When the plastic film is adhered to form the protective layer, it is possible to make the personal information, which is indicated by the information indicating part 40, illegible by peeling off the protective layer 50 and then by scrubbing the image-receiving layer 30 while a pressure larger than a predetermined pressure is applied to the image-receiving layer. Like the adhesive tape described in the first embodiment, even though the plastic film is peeled off, the image-receiving layer 30 and the protective layer 50 are not peeled from the release layer 20.

Further, when the water-soluble resin is applied to form the protective layer, it is possible to make the personal information, which is indicated by the information indicating part 40, illegible by wetting the protective layer 50 with water and then by scrubbing the image-receiving layer 30 while a pressure larger than a predetermined pressure is applied to the image-receiving layer.

Furthermore, when the waterproof resin is applied to form the protective layer, it is possible to make the personal information, which is indicated by the information indicating part 40, illegible by scrubbing the image-receiving layer 30 while a pressure larger than a predetermined pressure is applied to the image-receiving layer from above the protective layer. In addition, if a rubber resin is added to the waterproof resin, chips of the ink-layer 30, the information indicating part 40, and the protective layer 50 are lumped and not scattered. For this reason, it is preferable that a rubber resin be added to the waterproof resin.

According to the personal information protecting sheet of the present invention, like in the first embodiment, the image-receiving layer 30 is peeled and removed from the release layer 20 by scrubbing the image-receiving layer 30 while a pressure larger than a predetermined pressure is applied to the image-receiving layer. For this reason, when personal information is indicated on the image-receiving layer 30 by the information indicating part 40, the image-receiving layer and the information indicating part are peeled and removed at the same time. As a result, when the personal information protecting sheet on which personal information is indicated is destroyed, it is possible to make the personal information illegible with a simple operation and to prevent the personal information from leaking from the destroyed sheet.

Further, as shown in FIG. 15, a protective layer 50 may be provided to the personal information protecting sheet having the layer structure shown in FIG. 11.

### FOURTH EMBODIMENT

A fourth preferred embodiment will be described below. A personal information protecting label according to the present embodiment has the same structure as the personal information protecting sheet according to the first embodiment.

In this case, as shown in FIG. 16(a), an adhesive strength between an adhesion object 100 and an adhesive layer 70 is denoted by “α”, an adhesive strength between the adhesive layer 70 and a base material 10 is denoted by “β”, an adhesive strength between the base material 10 and a release layer 20 is denoted by “γ”, and an adhesive strength between the release layer 20 and an image-receiving layer 30 is denoted by “δ” (the unit of the adhesive strength is arbitrary). In this case, α>δ, β>δ, and γ>δ are satisfied (more preferably, γ>β>α>δ is satisfied).

If the adhesive strength between the adhesive layer 70 and the adhesion object 100 is set to be larger than that between the release layer 20 and the image-receiving layer 30, the entire personal information protecting label is not peeled off during the scrubbing of the image-receiving layer 30 with a coin or the like. Further, if the adhesive strength between the adhesive layer 70 and the base material 10 and the adhesive strength between the base material 10 and the release layer 20 are set to be larger than that between the release layer 20 and the image-receiving layer 30, a part of the personal information protecting label is not peeled off during the scrubbing of the image-receiving layer 30 with a coin or the like.

Furthermore, when the information protecting label does not include the image-receiving layer 30, as shown in FIG. 16(b), if the adhesive strength between the release layer 20 and an information indicating part 40 is denoted by “ε” and α>ε, β>ε, and γ>ε are satisfied (more preferably, γ>β>α>ε is satisfied), it is possible to obtain the same effect as described above.

Each of the adhesive strengths α, β, γ, δ, and ε between the members is not limited to a specific value. However, when the adhesive strength between the release paper (which comes in contact with the adhesive layer 70 before the release layer is adhered to the adhesion object 100) and the adhesive layer 70 is measured by a 180-degree peeling method of JIS Z 0237, the adhesive strength between the release layer and the adhesive layer may be in the range of 1800 to 2700 gs/25 mm. When the adhesive strength between the adhesive layer 70 and the release paper is determined, the adhesive strength α between the adhesion object 100 and the adhesive layer 70 is also determined. Accordingly, the composition of each layer may be controlled based on the adhesive strength α so that β, γ, δ, and ε satisfy the above-mentioned relationships.

### FIFTH EMBODIMENT

A fifth preferred embodiment of the present invention will be described below. A personal information protecting sheet according to the present embodiment has the same structure as the personal information protecting sheet according to the first embodiment.

As shown in FIG. 17, personal information such as address or name is printed only at a portion of the personal information protecting sheet, and at least one unprinted region 110 is formed on the surface of the personal information protecting sheet. When a user makes personal information illegible, the unprinted region 110 is pressed with a finger and an image-receiving layer 30 is then scrubbed with a coin or the like. Accordingly, it is possible to make all personal information illegible without holding again the personal information protecting sheet. If an unprinted region is not formed on the personal information protecting sheet, the personal information protecting sheet should be held again to make illegible the information under the region, which is initially pressed with a finger. As described above, if an unprinted region 110 is formed on the personal information protecting sheet, user's efforts is reduced.

When the unprinted region 110 is too small, a contacting surface of a finger or hand holding the sheet protrudes from the unprinted region. Accordingly, unless the personal information protecting sheet is held again, it is not possible to make all personal information illegible. For this reason, the unprinted region 110 needs to have an area as large as the finger or hand holding the sheet does not protrude from the unprinted region (an area including a 1 cm×1 cm square so that at least tip of the finger does not protrude from the unprinted region).

When personal information is printed on an unprinted personal information protecting sheet, it goes without saying that it is preferable that an information indicating part 40 be formed to ensure the unprinted region.

Meanwhile, since a user easily makes personal information illegible, it is preferable that the unprinted region 110 is formed at the peripheral portion of the image-receiving layer 30 (a release layer 20 when the personal information protecting sheet does not include an image-receiving layer). Further, if the unprinted region 110 is formed at the left end so as to face printed personal information, many users can easily make personal information illegible (since there are many cases that a right-handed person holds the personal information protecting sheet with a left hand and holds a coin with a right hand to scrub the sheet).

Two or more unprinted regions (for example, left and right ends or four corners) may be formed on the surface of the personal information protecting sheet.

### SIXTH EMBODIMENT

A sixth preferred embodiment will be described below. A personal information protecting sheet according to the present embodiment has the same structure as the personal information protecting sheet according to the first embodiment.

As shown in FIG. 18, an image-receiving layer 30 (a release layer 20 when the personal information protecting sheet does not include an image-receiving layer) is formed only on a part of a base material 10 in a personal information protecting sheet according to the present embodiment. Further, nonvolatile information 120 is indicated at a portion on which a release layer 20 is not formed. The contents of the nonvolatile information 120 is arbitrary, but it is preferable that the contents of the nonvolatile information be information relating to the personal information indicated by an information indicating part 40. For example, if a user ID is indicated by the nonvolatile information 120 when user's address and name are written as personal information, it is possible to specify the contents of the printed personal information from the nonvolatile information 120 even though the personal information is destroyed due to arbitrary reasons.

When the personal information protecting sheet is used as a postcard or a destination label adhered to an envelope or parcel post, the personal information protecting sheet comes in contact with other mails during the mailing, so that the image-receiving layer 30 is scrubbed. For this reason, there is an undesirable possibility that personal information (destination information) indicated by the information indicating part 40 becomes illegible. Even in this case, if information relating to the information indicating part 40 is indicated by the nonvolatile information 120, it is possible to restore the personal information. Accordingly, in particular, the personal information protecting sheet according to the present embodiment may be preferably used as a postcard or address label.

Unless the nonvolatile information 120 is covered or the personal information protecting sheet is cut into several pieces, the nonvolatile information 120 becomes not illegible. For this reason, it is preferable that the nonvolatile information is encoded and indicated by an arbitrary method. In particular, when the nonvolatile information 120 is information relating to personal information, if the nonvolatile information 120 is encoded to be indicated (for example, indicated by a bar code), it is difficult to guess personal information from the nonvolatile information 120. As a result, it is possible to prevent the revelation of the personal information.

### SEVENTH EMBODIMENT

A seventh preferred embodiment will be described below. A personal information protecting sheet according to the present embodiment has the same structure as the personal information protecting sheet according to the first or second embodiment. However, as shown in FIG. 19, a release layer is formed only on a partial region of a base material 10.

FIG. 20 is a view showing that an image-receiving layer 30 is scratched from a release layer 20.

As shown in FIG. 20, the image-receiving layer 30 and the information indicating part 40 formed on the image-receiving layer 30 are simultaneously peeled and removed from the release layer 20 by scratching the image-receiving layer with a coin or nail (in other words, by scrubbing the image-receiving layer 30 while a pressure larger than a predetermined pressure is applied to the image-receiving layer). Further, the adherence between the image-receiving layer 30 and the release layer 20 can be controlled by the composition of mixtures used as base materials of the release layer 20 and the image-receiving layer 30. Meanwhile, even though being scrubbed with a coin or nail, the information indicating part 40 formed on the base material 10 is not peeled off.

As shown in FIG. 21(a), the image-receiving layer 30 (the release layer 20 when the personal information protecting sheet does not include an image-receiving layer) is formed to have the shape of an arbitrary pattern. Accordingly, the amount of a material required to form the image-receiving layer 30 and the release layer 20 is smaller compared to when the image-receiving layer and the release layer are formed by solid printing.

When the image-receiving layer 30 is scratched with a coin or nail, the information indicating part 40 is removed to have the same shape as the pattern of the image-receiving layer 30 as shown in FIG. 21(b). In this case, even though the information indicating part 40 is not completely removed, the personal information becomes illegible. However, if the pattern is too large even though the shape of the pattern is arbitrary, there is an undesirable possibility that the information indicating part 40 legibly remains. Accordingly, the design of the pattern needs to be determined in consideration of the size of the information indicating part 40.

As shown in FIG. 22(a), personal information such as address or name is generally printed only on a part of the personal information protecting sheet. Accordingly, if the personal information protecting sheet includes an image-receiving layer 30, a portion from which the image-receiving layer 30 is only a portion corresponding to address or name as shown in FIG. 22(b). Since the entire image-receiving layer 30 need not be scratched like a so-called conventional “scratch card”, it is possible to minimize the amount of scratched chips. Further, as shown FIG. 22(c), the image-receiving layer 20 and the release layer 20 may be formed so that only a part of the personal information indicated by the information indicating part 40 becomes illegible. For example, since it is difficult to specify a person by only a city name of address or an area code of a telephone number, portions corresponding to the city name or area code (parts of the personal information shared by unspecified persons) do not need to become illegible.

Further, the release layer 20 and the image-receiving layer 30 have been formed to have shapes of arbitrary patterns in the present embodiment. However, as shown in FIG. 23(a), the only release layer 20 may be formed to have the shape of an arbitrary pattern, and the image-receiving layer 30 may be formed on the entire surface of the base material. In this case, as shown in FIG. 23(b), when the image-receiving layer is scrubbed with a coin or the like, the image-receiving layer 30 and information indicating part 40 are peeled off and removed only at positions where the image-receiving layer 30 overlaps with the release layer 20.

It goes without saying that it is possible to obtain the same effect even in the above-mentioned structure.

The release layer 20 has been formed on the sheet (or label) without spaces to peel off the base material in the above-mentioned embodiment. However, if the release layer 20 is formed on the sheet (or label) to have the shape of a pattern, a material of the release layer 20 is saved and cost is reduced.

### EIGHTH EMBODIMENT

An eighth preferred embodiment will be described below. A personal information protecting sheet according to the present embodiment has the same structure as the personal information protecting sheet according to the first embodiment.

A release layer 20, an image-receiving layer 30, and an information indicating part 40 may be formed by a variable printing technique. That is, as shown in FIG. 24, printing area data is previously created based on address data, and each of layers may be formed with a variable printer based on the address data and the printing area data.

The shape and size of a region occupied by the release layer 20 and the image-receiving layer 30 corresponds to the shape and size of a region occupied by information, which is indicated by the information indicating part 40. For example, as shown in FIG. 25(a), when the information indicated by the information indicating part 40 occupies a region of a×b and a region of c×d, the image-receiving layer 30 is formed in regions slightly larger than the regions (for example, a region of (a+α)×(b+β) and a region of (c+γ)×(d+δ), where each of α, β, γ, and δ is a positive number).

Accordingly, as shown in FIG. 25(b), the image-receiving layer 30 is formed in a region larger than the region occupied by the information, which is indicated by the information indicating part 40. For this reason, it is possible to reduce the amount of a material, which is used to form the image-receiving layer 30.

As a result, manufacturing cost of the personal information protecting sheet is reduced.

As shown in FIG. 26, in general, a region occupied by personal information such as address or name is a part of the surface of the personal information protecting sheet (for example, a margin exists around the information or between lines). Accordingly, even though the release layer 20 and the image-receiving layer 30 are formed only in a region larger than the region occupied by the information, which is indicated by the information indicating part 40, the image-receiving layer 30 occupies only a part of the surface of the personal information protecting sheet. Accordingly, it is possible to prevent the waste of materials of the release layer 20 and the image-receiving layer 30, and to reduce manufacturing cost thereof.

### NINTH EMBODIMENT

A ninth preferred embodiment will be described below. FIG. 27 shows the structure of a personal information protecting sheet according to the present embodiment. The personal information protecting sheet is a sheet in which a surface inactive radiation curing resin layer used as a release layer 20 and a resin layer having a small cohesive force used as an image-receiving layer 30 are sequentially built up on one surface of a base material 10 (paper, an envelope, a postcard, label, or the like). In this case, the base material is used to write personal information thereon. The release layer 20 is transparent, and the image-receiving layer 30 is opaque. Further, confidential information 170 is printed between the base material 10 and the release layer 20.

The image-receiving layer 30 has a small adherence to the release layer 20. When a force substantially parallel to the base material 10 is locally applied to the image-receiving layer (the image-receiving layer is scrubbed with a coin or nail), the image-receiving layer is peeled from an interface between the image-receiving layer and the release layer 20. In the personal information protecting sheet in which personal information such as address, name, or phone number is indicated by an information indicating part 40 that is formed on the surface of the image-receiving layer 30 by a known printing method (formation by a printer using ink or toner, printing, formation by handwriting with a pencil, or the like), if the image-receiving layer 30 is scrubbed with a coin or nail, it is possible to peel off the image-receiving layer and the personal information (information indicating part 40) formed on the surface of the image-receiving layer 30 at the same time. Accordingly, it is possible to prevent personal information from being revealed from the destroyed mail.

When the image-receiving layer 30 is scratched, the confidential information 170 is visible through the release layer 20. The contents of the confidential information 170 is arbitrary (advertisement of products, winning or losing of a lottery, or the like), but may be the contents relating to a user (the contents relating to user's taste). For example, when the personal information protecting sheet according to the present embodiment is used as a destination label adhered to an envelope that is used to mail a credit card statement, personal information such as an address and a name is indicated with the information indicating part 40 by using previously registered user's personal information and receiver's obtained points or fortune-telling corresponding to user's personal information (constellation fortune-telling, blood type fortune-telling, or the like) may be printed as confidential information. Accordingly, it is possible to motivate a user to peel off the image-receiving layer 30. For this reason, even though being careless about the prevention of the revelation of personal information, a user unintentionally prevents the personal information from being revealed.

FIG. 28(a) is a view showing that the image-receiving layer 30 is scratched from the release layer 20.

As shown in FIG. 28(a), the image-receiving layer 30 and the information indicating part 40 formed on the image-receiving layer 30 are simultaneously peeled and removed from the release layer 20 by scratching the image-receiving layer with a coin or nail (in other words, by scrubbing the image-receiving layer 30 while a pressure larger than a predetermined pressure is applied to the image-receiving layer). Further, the adherence between the image-receiving layer 30 and the release layer 20 can be controlled by the composition of mixtures used as base materials of the release layer 20 and the image-receiving layer 30. As shown in FIG. 28(b), when the image-receiving layer 30 is removed, the hidden confidential information 170 is visible through the release layer 20.

Further, when the information relating to user's personal information is indicated by the confidential information 170, an attention attracting part 60 may indicate messages such as “if you scrub a portion corresponding to a destination, you will see your points”, “if you scratch a portion corresponding to a destination, you will see your fortune”, or “interesting information is hidden under a destination!” as shown in FIG. 29 as well as that the image-receiving layer 30 can be peeled from the release layer 20.

In addition, since the confidential information 170 is hidden under the image-receiving layer 30, it is possible to motivate a user to peel off the image-receiving layer 30.

The above-mentioned embodiments are only preferred examples of the present invention, and the present invention is not limited thereto. The personal information protecting sheet in which personal information is indicated on the image-receiving layer 30 by the information indicating part 40 has been exemplified in the above-mentioned embodiments. However, the information indicated by the information indicating part 40 is not limited to personal information, and may be arbitrary letters, sentences, designs, or the like. Further, the size (area) of the release layer does not need to necessarily be the same as that of the image-receiving layer. That is, the image-receiving layer may be formed on a part of the release layer, and the image-receiving layer may be partially formed in a region in which the release layer is not formed.

The present invention may have various modifications as described above.

### BRIEF DESCRIPTION OF THE DRAWINGS

FIG. 1 is a view showing the structure of a personal information protecting sheet according to a first embodiment;

FIG. 2 is a view showing a base material on which incisions are formed to reduce mechanical strength;

FIG. 3 is a view showing that an image-receiving layer of the personal information protecting sheet according to the first embodiment is peeled and removed;

FIG. 4(a) is a view showing the personal information protecting sheet on which personal information is printed;

FIG. 4(b) is a view showing that the personal information was peeled and removed;

FIG. 5 is a view illustrating difference when an information indicting part is formed on the personal information protecting sheet by an impact printing method and when an information indicting part is formed on the personal information protecting sheet by a non-impact printing method;

FIG. 6 is a view showing that an index indicating that the image-receiving layer can be peeled off is indicated on the personal information protecting sheet;

FIG. 7 is a view showing the structure of a personal information protecting sheet including a cushion layer;

FIG. 8 is a view showing that the image-receiving layer and the release layer are deformed due to the cushioning property of the cushion layer so as to correspond to the pressure applied from a coin or the like;

FIG. 9 is a view showing the structure of a personal information protecting sheet including a base material that has a cushioning property;

FIG. 10 is a view showing the shape of a window envelope in which the personal information protecting sheet is received;

FIG. 11 is a view showing another structure of the personal information protecting sheet according to the first embodiment;

FIG. 12 is a view showing that ink is peeled and removed from a personal information protecting sheet having another structure according to the first embodiment;

FIG. 13 is a view showing an interface between a base material and a release layer of a personal information protecting sheet according to a second embodiment;

FIG. 14 is a view showing the structure of a personal information protecting sheet according to a third embodiment;

FIG. 15 is a view showing another structure of the personal information protecting sheet according to the third embodiment;

FIG. 16 is a view showing relationships between the adhesive strength of a personal information protecting label according to a fourth embodiment to an adhesion object and the adhesive strength of each layer in the label;

FIG. 17 is a view showing an unprinted region of a personal information protecting sheet according to a fifth embodiment;

FIG. 18 is a view showing nonvolatile information of a personal information protecting sheet according to a sixth embodiment;

FIG. 19 is a view showing the structure of a personal information protecting sheet according to a seventh embodiment;

FIG. 20 is a view showing that an image-receiving layer is peeled and removed from a personal information protecting sheet according to a ninth embodiment;

FIG. 21(a) is a view showing an image-receiving layer, which is formed on the personal information protecting sheet according to the seventh embodiment to have the shape of a pattern, and an information indicating part formed on the image-receiving layer;

FIG. 21(b) is a view showing that the image-receiving layer is scratched;

FIG. 22(a) is a view showing that personal information is printed on the personal information protecting sheet according to the seventh embodiment;

FIG. 22(b) is a view showing that the personal information is peeled and removed;

FIG. 23 is a view showing the structure of a personal information protecting sheet in which only an image-receiving layer is formed to have the shape of a pattern, and that personal information formed on the personal information protecting sheet is illegible;

FIG. 24 is a view showing the structure of an apparatus for forming a personal information protecting sheet according to an eighth embodiment by a variable printing technique;

FIG. 25 is a view showing a relationship between the size of a region on which information is indicated by an information indicating part and the size of a region on which an image-receiving layer is formed, in the personal information protecting sheet according to the eighth embodiment;

FIG. 26 is a view showing a personal information protecting sheet, on which personal information is printed, according to the eighth embodiment;

FIG. 27 is a view showing the structure of the personal information protecting sheet according to the ninth first embodiment;

FIG. 28(a) is a view showing that an image-receiving layer is peeled and removed;

FIG. 28(b) is a view showing that personal information is peeled and removed; and

FIG. 29 is a view showing that an index indicating that the image-receiving layer can be peeled off is indicated on the personal information protecting sheet.

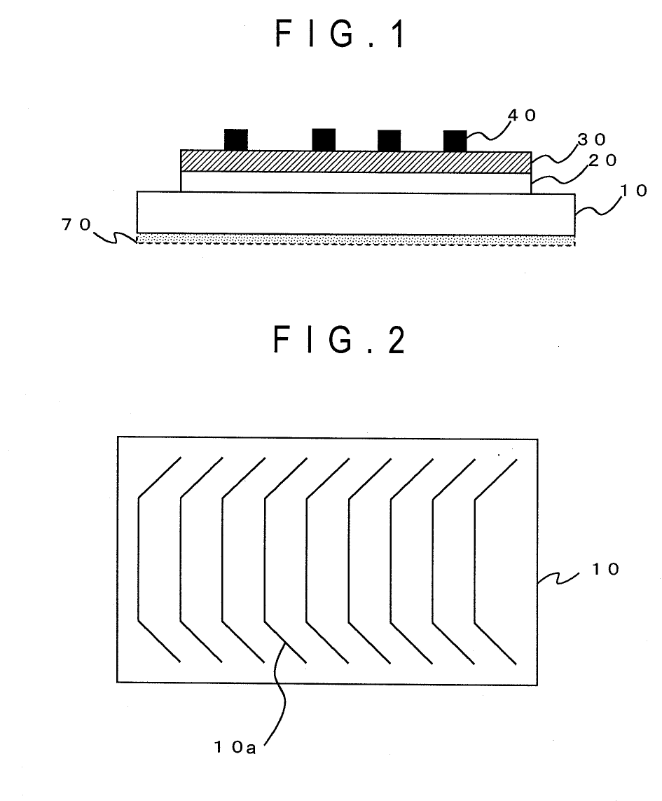

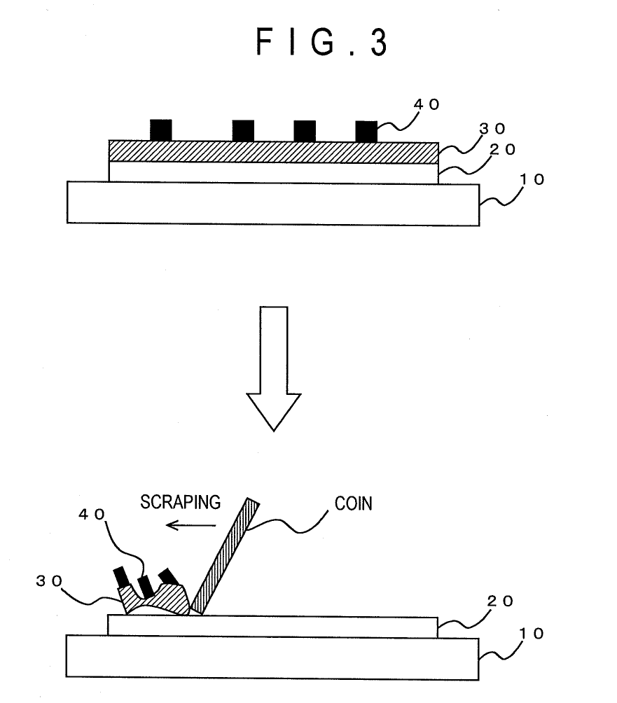

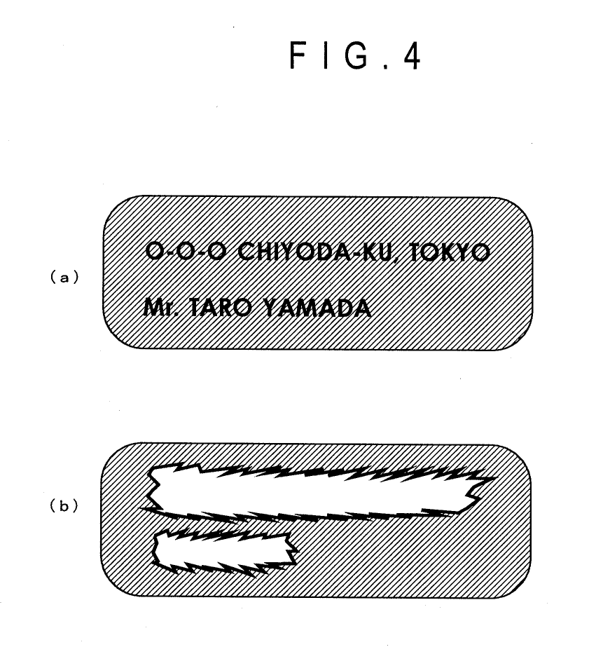

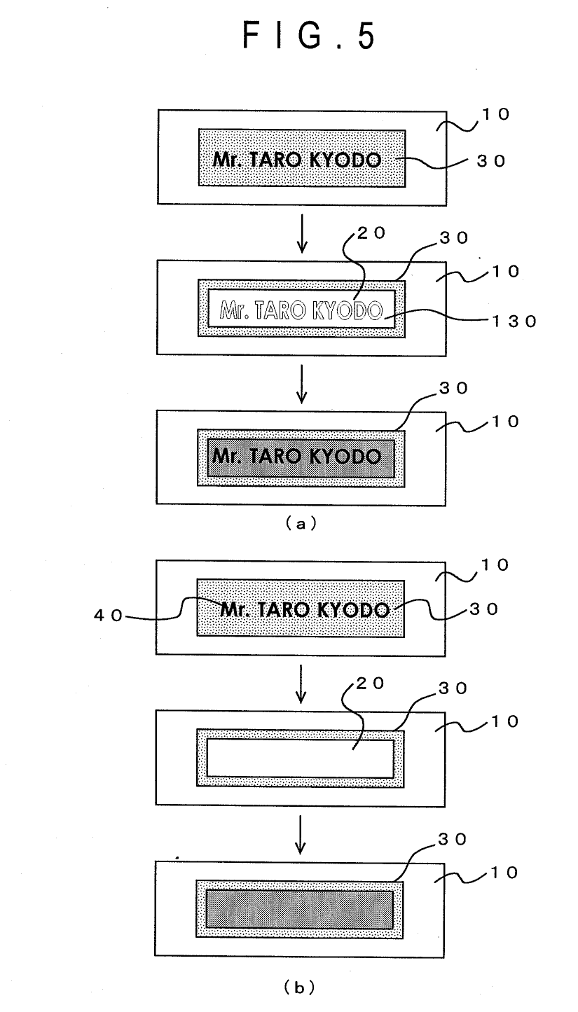

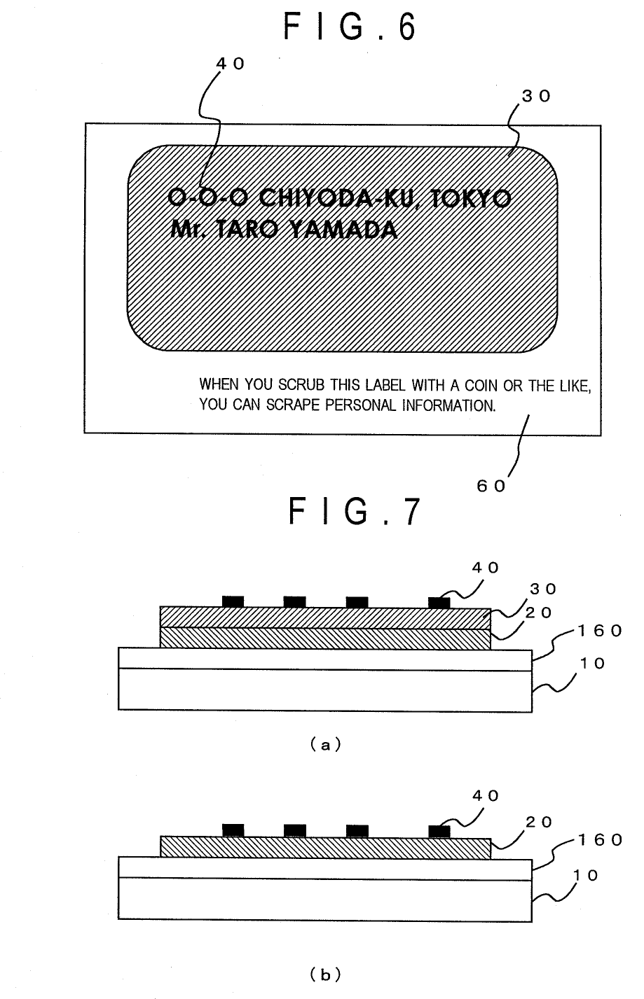

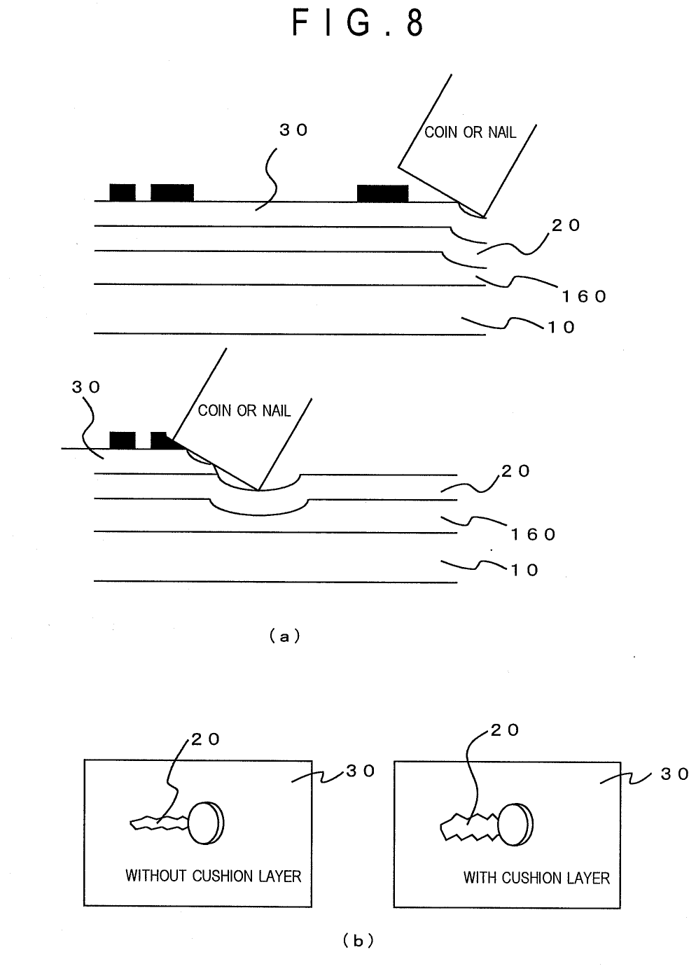

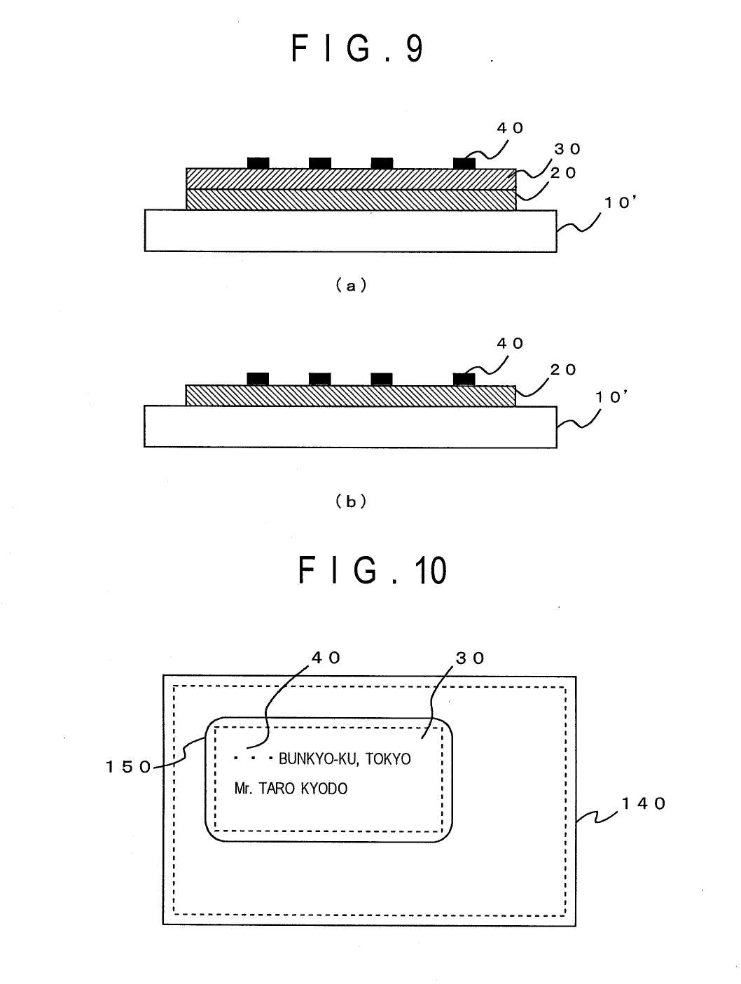

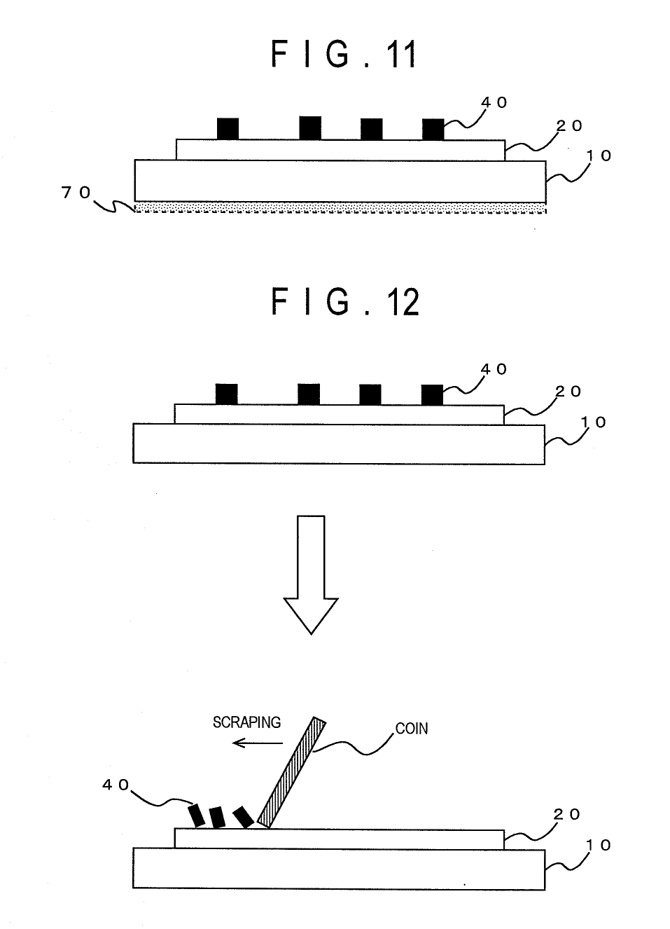

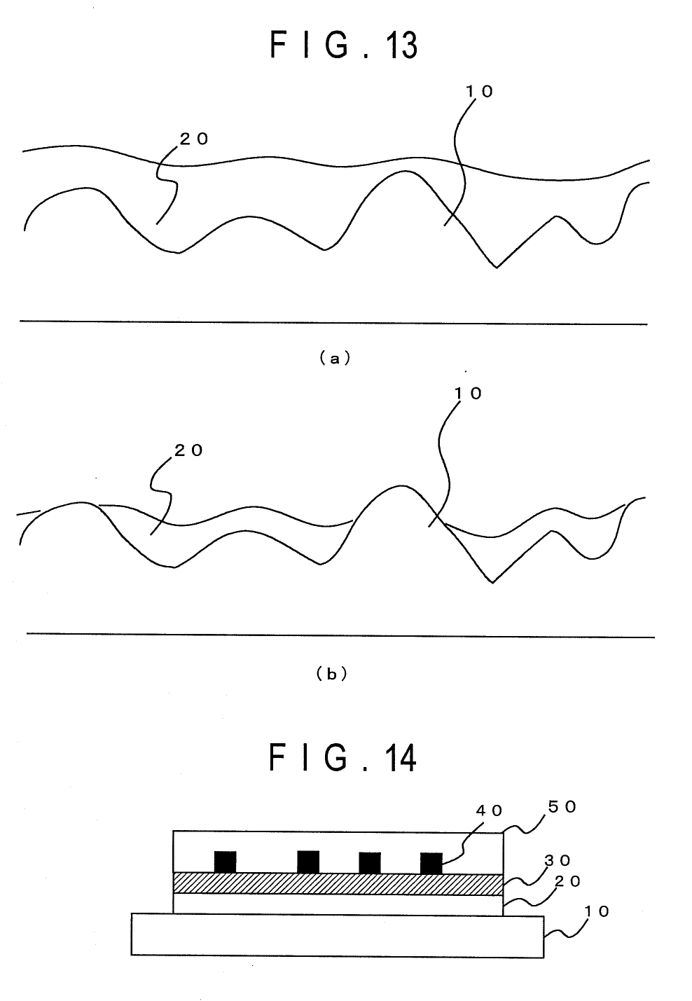

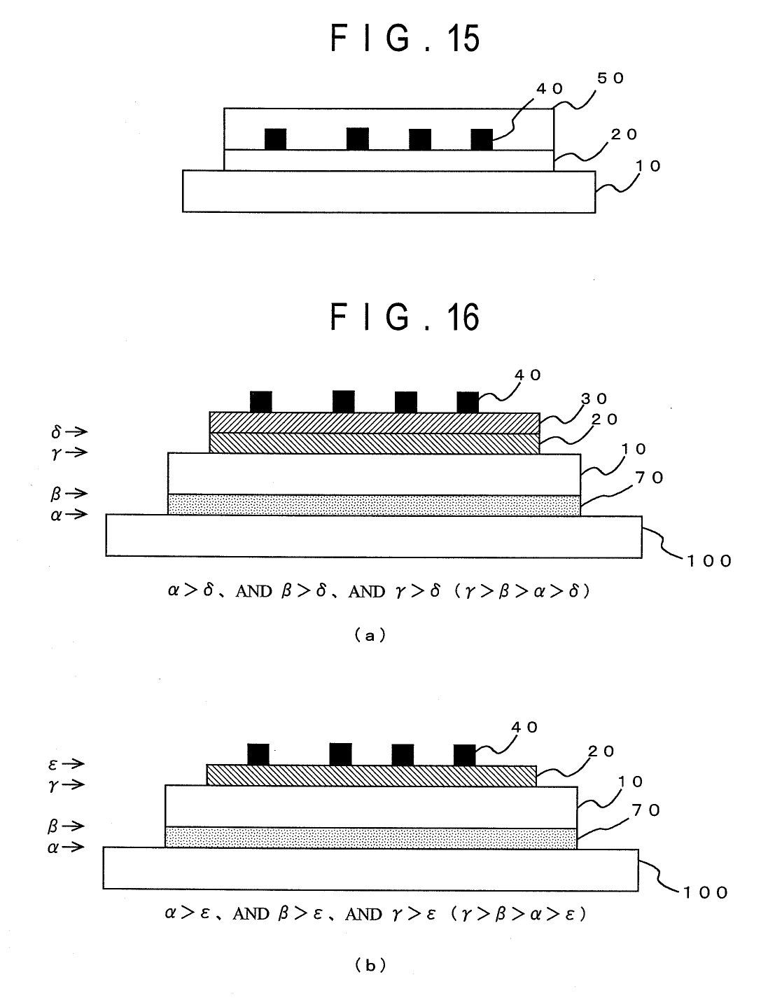

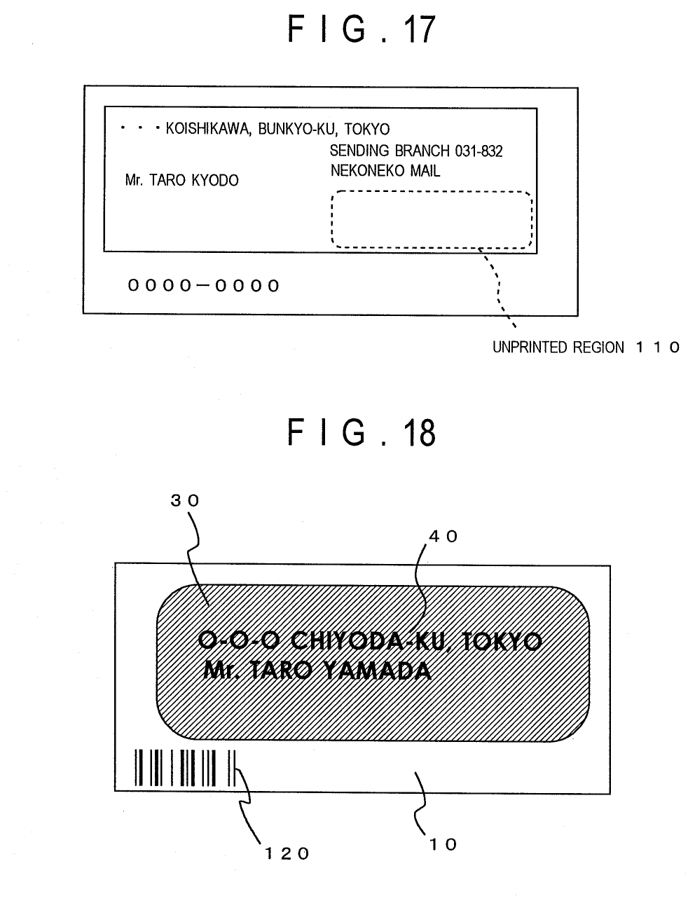

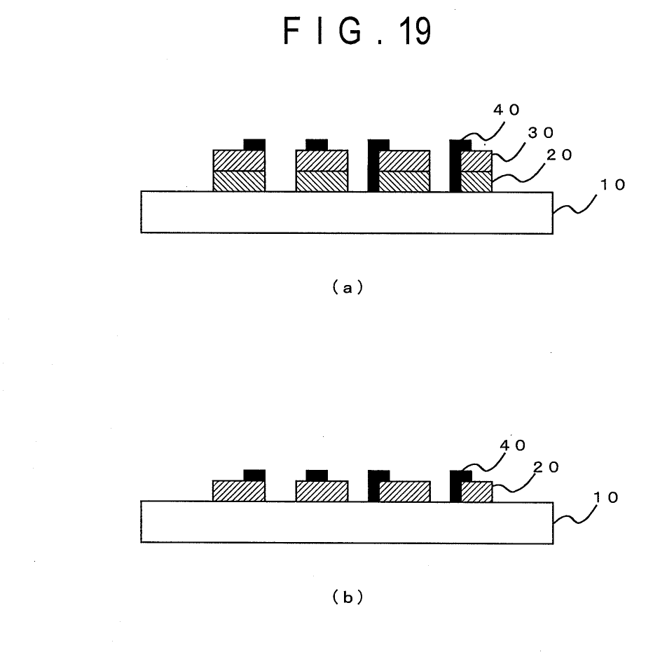

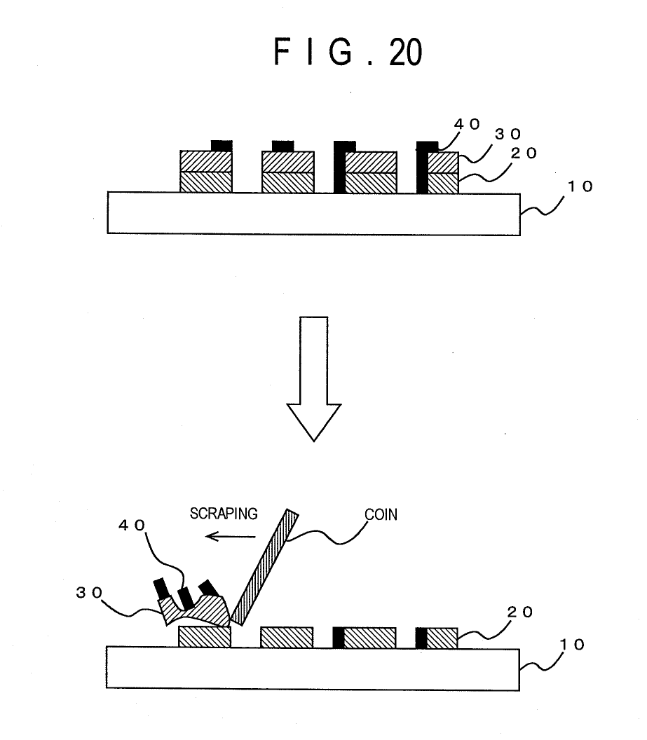

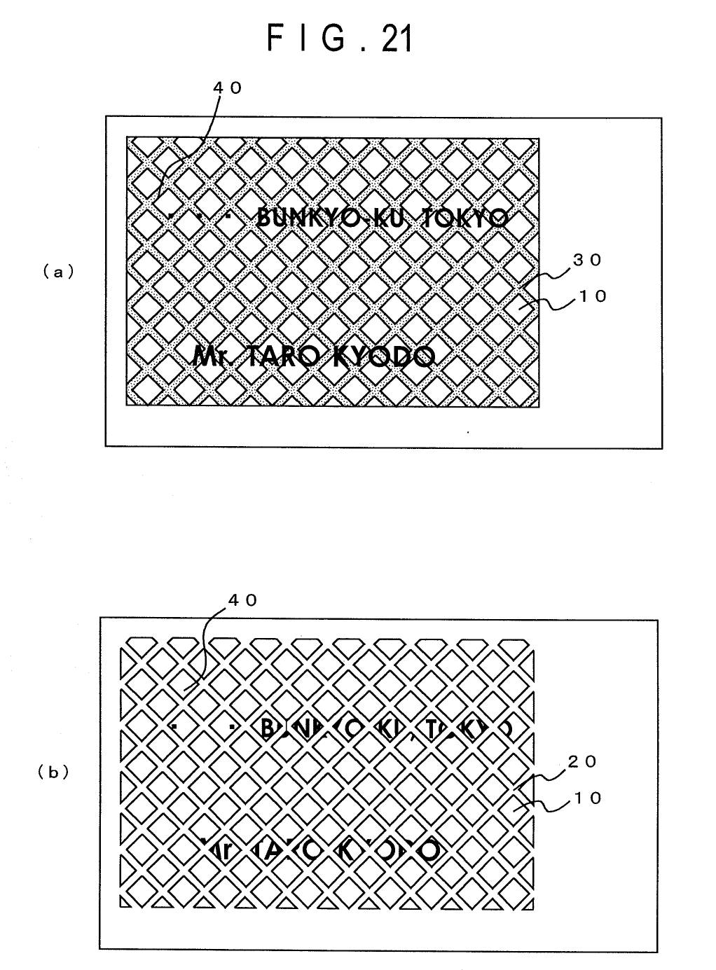

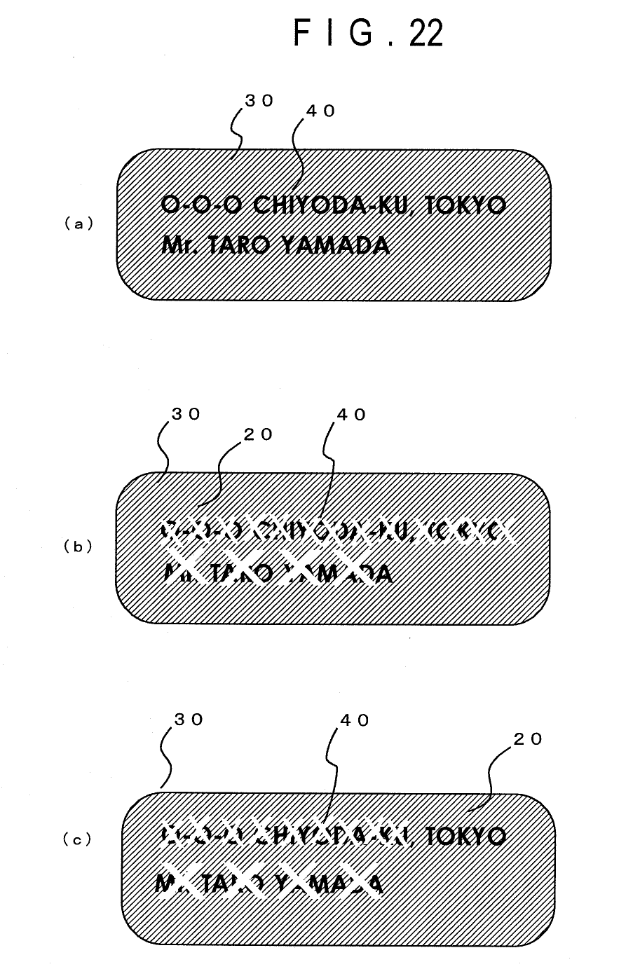

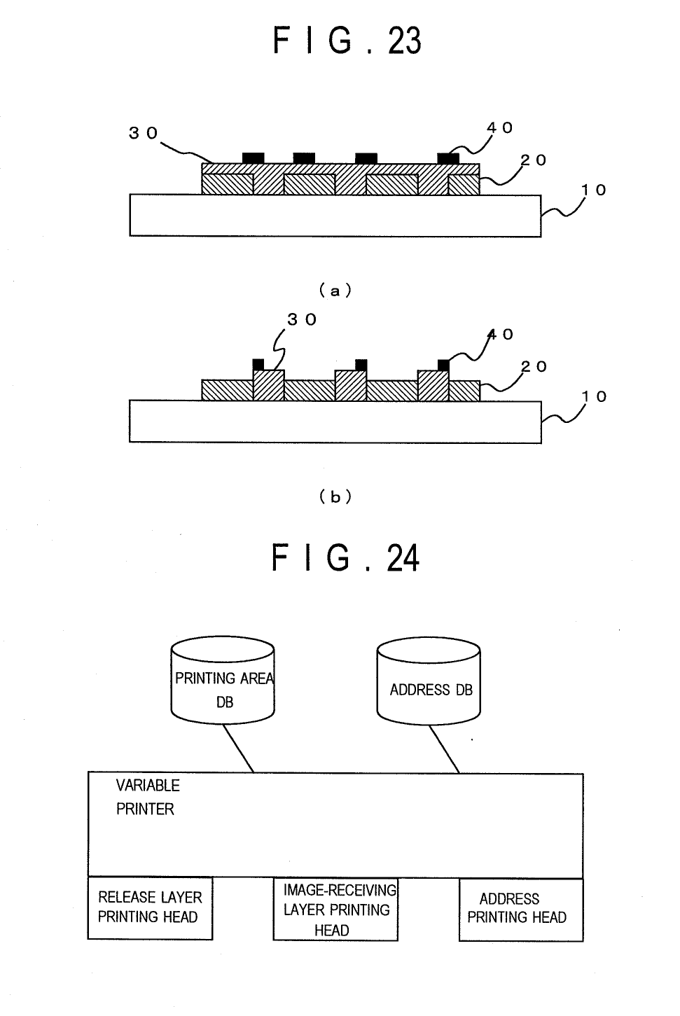

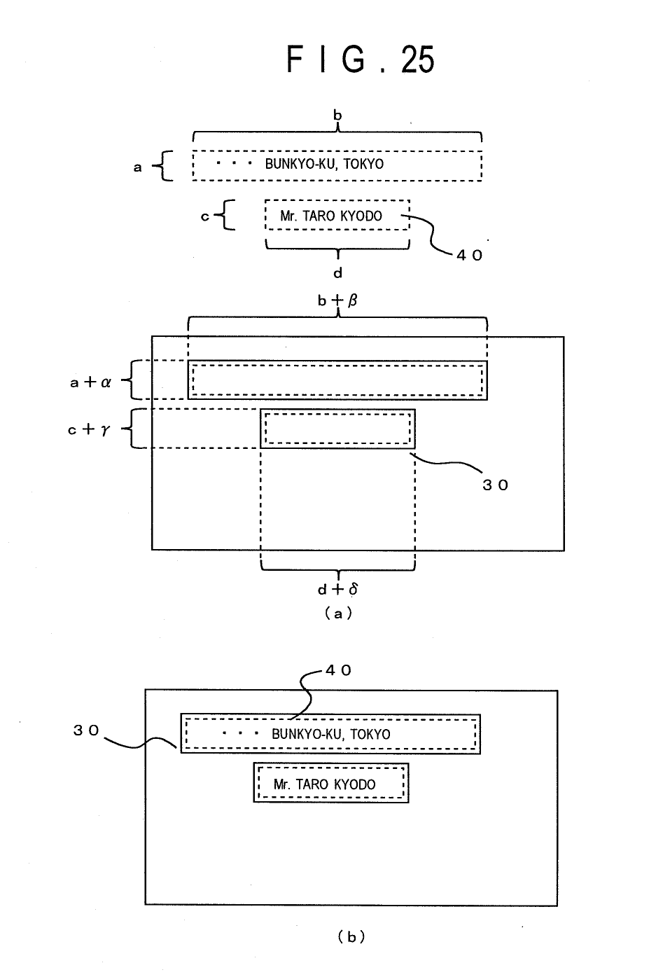

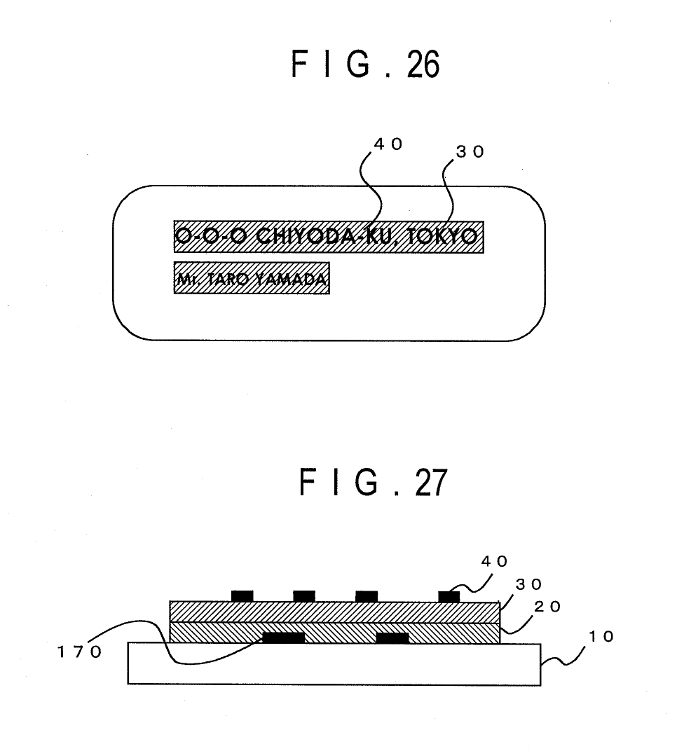

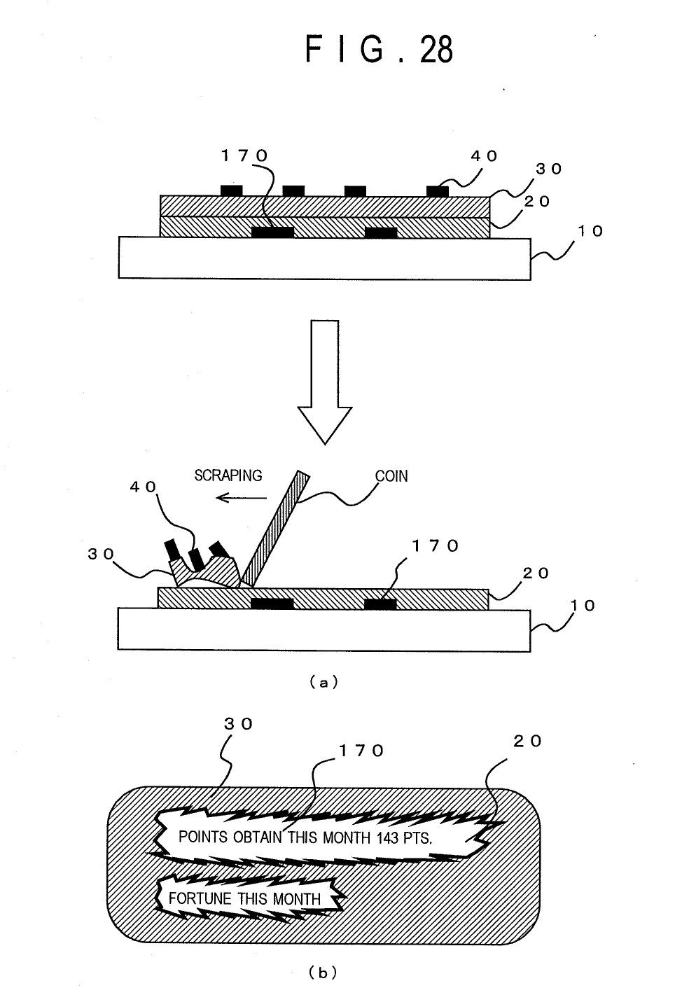

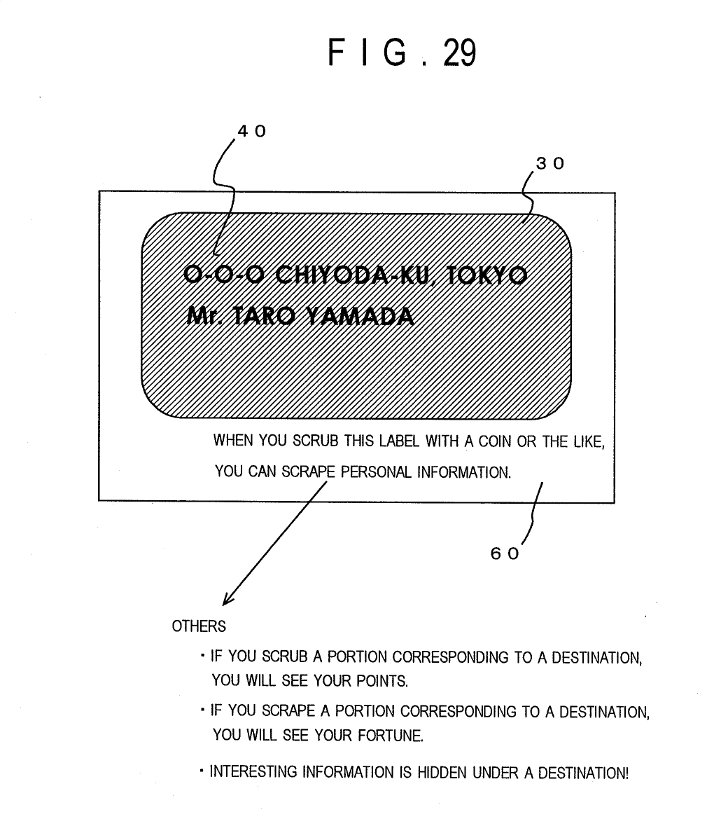

Reference Numerals

| | |
|---|---|
| 10, 10′: | base material |
| 20: | release layer |
| 30: | image-receiving layer |
| 40: | information indicating part |
| 50: | protective layer |
| 60: | attention attracting part |
| 70: | adhesive layer |
| 100: | adhesion object |
| 110: | unprinted region |
| 120: | nonvolatile information |
| 130: | printing mark |
| 140: | window envelope |
| 150: | window |
| 160: | cushion layer |
| 170: | confidential information |

1. A personal information protecting sheet comprising:
a base material;
a release layer formed on at least a part of the base material; and
an image-receiving layer formed on the release layer.

2. The personal information protecting sheet according to claim 1,
wherein an information indicating part that indicates information relating to a specified person is formed on the image-receiving layer.

3. The personal information protecting sheet according to claim 1,
wherein the release layer is formed to have the shape of a predetermined pattern.

4. The personal information protecting sheet according to claim 3,
wherein an information indicating part that indicates information relating to a specified person is formed so that at least a part of the information indicating part is formed on the image-receiving layer.

5. A personal information protecting sheet comprising:
a base material;
a confidential information part formed on one surface of the base material;
a transparent release layer formed on at least a part of the base material so as to cover the confidential information part; and
an opaque image-receiving layer formed on the release layer.

6. The personal information protecting sheet according to claim 5,
wherein an information indicating part that indicates information relating to a specified person is formed on the image-receiving layer.

7. The personal information protecting sheet according to claim 6,
wherein information indicated by the confidential information part is related to information indicated by the information indicating part.

8. The personal information protecting sheet according to claim 2,
wherein at least one personal information unprinted region on which the information indicating part is not formed is formed on the image-receiving layer.

9. The personal information protecting sheet according to claim 8,
wherein the personal information unprinted region is formed at the peripheral portion of the image-receiving layer.

10. The personal information protecting sheet according to claim 8,
wherein the personal information unprinted region has a shape including a 1 cm×1 cm square.

11. The personal information protecting sheet according to claim 2,
wherein information relating to the information indicated by the information indicating part is indicated on the base material in a region in which the release layer is not formed.

12. The personal information protecting sheet according to claim 11,
wherein the information relating to the information indicated by the information indicating part is encoded.

13. The personal information protecting sheet according to claim 2,
wherein at least the image-receiving layer is formed only on a region having substantially the same shape as a region occupied by the information indicating part.

14. The personal information protecting sheet according to claim 2, further comprising:
an attention attracting part for indicating that the image-receiving layer can be peeled from the release layer.

15. The personal information protecting sheet according to claim 14,
wherein the attention attracting part is formed in a region in which the release layer is not formed.

16. The personal information protecting sheet according to claim 1,
wherein the image-receiving layer has color different from the base material.

17. The personal information protecting sheet according to claim 1, further comprising:
an adhesive layer formed on a surface opposite to the surface, on which layers are formed, of the base material.

18. The personal information protecting sheet according to claim 17,
wherein the adhesive strength between the adhesive layer and an adhesion object is higher than the adhesive strength between the release layer and the image-receiving layer.

19. A personal information protecting sheet comprising:
a base material; and
a release layer that is formed on at least a part of the base material and is peeled from an information indicating part, the information indicating part being formed on the release layer and indicating information relating to a specified person.

20. The personal information protecting sheet according to claim 19,
wherein information, which indicates the information relating to a specified person, is indicated by the information indicating part.

21. The personal information protecting sheet according to claim 19,
wherein the release layer is formed to have the shape of a predetermined pattern.

22. The personal information protecting sheet according to claim 21,
wherein an information indicating part that indicates information relating to a specified person is formed so that at least a part of the information indicating part is formed on the release layer.

23. The personal information protecting sheet according to claim 20,
wherein at least one personal information unprinted region on which the information indicating part is not formed is formed on the release layer.

24. The personal information protecting sheet according to claim 23,
wherein the personal information unprinted region is formed at the peripheral portion of the release layer.

25. The personal information protecting sheet according to claim 23,
wherein the personal information unprinted region has a shape including a 1 cm×1 cm square.

26. The personal information protecting sheet according to claim 20,
wherein information relating to the information indicated by the information indicating part is indicated on the base material in a region in which the release layer is not formed.

27. The personal information protecting sheet according to claim 26,
wherein the information relating to the information indicated by the information indicating part is encoded.

28. The personal information protecting sheet according to claim 20,
wherein the release layer is formed only on a region having substantially the same shape as a region occupied by the information indicating part.

29. The personal information protecting sheet according to claim 20, further comprising:
an attention attracting part for indicating that the information indicating part can be peeled from the release layer.

30. The personal information protecting sheet according to claim 29,
wherein the attention attracting part is formed on the base material in a region in which the release layer is not formed.

31. The personal information protecting sheet according to claim 19,
wherein the release layer has color different from the base material.

32. The personal information protecting sheet according to claim 19, further comprising:
an adhesive layer formed on a surface opposite to the surface, on which the release layer is formed, of the base material.

33. The personal information protecting sheet according to claim 32,
wherein the adhesive strength between the adhesive layer and an adhesion object is higher than the adhesive strength between the release layer and the information indicating part formed on the release layer.

34. The personal information protecting sheet according to claim 17,
wherein the base material is made of paper having a basis weight of 30 g/m² or more.

35. The personal information protecting sheet according to claim 17,
wherein incisions are formed in the base material.

36. The personal information protecting sheet according to claim 2, further comprising:
a protective layer, which is made of a transparent material, formed on the top.

37. The personal information protecting sheet according to claim 1, further comprising:
a layer that has a cushioning property and is provided between the release layer and the base material.

38. The personal information protecting sheet according to claim 1,
wherein the base material has a cushioning property.

39. The personal information protecting sheet according to claim 1,
wherein the release layer is formed to have a thickness, which is equal to or larger than a thickness corresponding to an arithmetic mean roughness on the surface of the base material.

40. An envelope with a personal information protecting sheet, comprising:
a personal information protecting sheet according to claim 2; and
a receiving bag for receiving the personal information protecting sheet,
wherein a position of the receiving bag corresponding to at least the information indicating part is formed to be transparent or translucent.

41. The envelope according to claim 40,
wherein the receiving bag includes a transparent or translucent window at a position corresponding to the information indicating part.

42. A method of manufacturing a personal information protecting sheet, the method comprising:
forming a base material;
forming a release layer on at least a part of one surface of the base material; and
forming an information indicating part, which indicates information relating to a specified person, on an image-receiving layer of stacked layers that includes an image-receiving layer formed on the release layer, by a non-impact printing method.

43. A method of manufacturing a personal information protecting sheet, the method comprising:
forming a base material; and
forming by a non-impact printing method an information indicating part that indicates information relating to a specified person on a release layer of stacked layers that includes a release layer formed on at least a part of one surface of the base material.

44. The personal information protecting sheet according to claim 4,
wherein at least one personal information unprinted region on which the information indicating part is not formed is formed on the image-receiving layer.

45. The personal information protecting sheet according to claim 6,
wherein at least one personal information unprinted region on which the information indicating part is not formed is formed on the image-receiving layer.

46. The personal information protecting sheet according to claim 4,
wherein information relating to the information indicated by the information indicating part is indicated on the base material in a region in which the release layer is not formed.

47. The personal information protecting sheet according to claim 6,
wherein information relating to the information indicated by the information indicating part is indicated on the base material in a region in which the release layer is not formed.

48. The personal information protecting sheet according to claim 4,
wherein at least the image-receiving layer is formed only on a region having substantially the same shape as a region occupied by the information indicating part.

49. The personal information protecting sheet according to claim 6,
wherein at least the image-receiving layer is formed only on a region having substantially the same shape as a region occupied by the information indicating part.

50. The personal information protecting sheet according to claim 4, further comprising:
an attention attracting part for indicating that the image-receiving layer can be peeled from the release layer.

51. The personal information protecting sheet according to claim 6, further comprising:
an attention attracting part for indicating that the image-receiving layer can be peeled from the release layer.

52. The personal information protecting sheet according to claim 3,
wherein the image-receiving layer has color different from the base material.

53. The personal information protecting sheet according to claim 5,
wherein the image-receiving layer has color different from the base material.

54. The personal information protecting sheet according to claim 3, further comprising:
an adhesive layer formed on a surface opposite to the surface, on which layers are formed, of the base material.

55. The personal information protecting sheet according to claim 5, further comprising:
an adhesive layer formed on a surface opposite to the surface, on which layers are formed, of the base material.

56. The personal information protecting sheet according to claim 22,
wherein at least one personal information unprinted region on which the information indicating part is not formed is formed on the release layer.

57. The personal information protecting sheet according to claim 22,
wherein information relating to the information indicated by the information indicating part is indicated on the base material in a region in which the release layer is not formed.

58. The personal information protecting sheet according to claim 22,
wherein the release layer is formed only on a region having substantially the same shape as a region occupied by the information indicating part.

59. The personal information protecting sheet according to claim 22, further comprising:
an attention attracting part for indicating that the information indicating part can be peeled from the release layer.

60. The personal information protecting sheet according to claim 21,
wherein the release layer has color different from the base material.

61. The personal information protecting sheet according to claim 21, further comprising:
an adhesive layer formed on a surface opposite to the surface, on which the release layer is formed, of the base material.

62. The personal information protecting sheet according to claim 32,
wherein the base material is made of paper having a basis weight of 30 g/m² or more.

63. The personal information protecting sheet according to claim 32,
wherein incisions are formed in the base material.

64. The personal information protecting sheet according to claim 4, further comprising:
a protective layer, which is made of a transparent material, formed on the top.

65. The personal information protecting sheet according to claim 6, further comprising:
a protective layer, which is made of a transparent material, formed on the top.

66. The personal information protecting sheet according to claim 20, further comprising:
a protective layer, which is made of a transparent material, formed on the top.

67. The personal information protecting sheet according to claim 22, further comprising:
a protective layer, which is made of a transparent material, formed on the top.

68. The personal information protecting sheet according to claim 3, further comprising:
a layer that has a cushioning property and is provided between the release layer and the base material.

69. The personal information protecting sheet according to claim 5, further comprising:
a layer that has a cushioning property and is provided between the release layer and the base material.

70. The personal information protecting sheet according to claim 19, further comprising:
a layer that has a cushioning property and is provided between the release layer and the base material.

71. The personal information protecting sheet according to claim 21, further comprising:
a layer that has a cushioning property and is provided between the release layer and the base material.

72. The personal information protecting sheet according to claim 3,
wherein the base material has a cushioning property.

73. The personal information protecting sheet according to claim 5,
wherein the base material has a cushioning property.

74. The personal information protecting sheet according to claim 19,
wherein the base material has a cushioning property.

75. The personal information protecting sheet according to claim 21,
wherein the base material has a cushioning property.

76. The personal information protecting sheet according to claim 3,
wherein the release layer is formed to have a thickness, which is equal to or larger than a thickness corresponding to an arithmetic mean roughness on the surface of the base material.

77. The personal information protecting sheet according to claim 5,
wherein the release layer is formed to have a thickness, which is equal to or larger than a thickness corresponding to an arithmetic mean roughness on the surface of the base material.

78. The personal information protecting sheet according to claim 19,
wherein the release layer is formed to have a thickness, which is equal to or larger than a thickness corresponding to an arithmetic mean roughness on the surface of the base material.

79. The personal information protecting sheet according to claim 21,
wherein the release layer is formed to have a thickness, which is equal to or larger than a thickness corresponding to an arithmetic mean roughness on the surface of the base material.

80. An envelope with a personal information protecting sheet, comprising:
a personal information protecting sheet according to claim 4; and
a receiving bag for receiving the personal information protecting sheet,
wherein a position of the receiving bag corresponding to at least the information indicating part is formed to be transparent or translucent.

81. An envelope with a personal information protecting sheet, comprising:
a personal information protecting sheet according to claim 6; and
a receiving bag for receiving the personal information protecting sheet,
wherein a position of the receiving bag corresponding to at least the information indicating part is formed to be transparent or translucent.

82. An envelope with a personal information protecting sheet, comprising:
a personal information protecting sheet according to claim 20; and
a receiving bag for receiving the personal information protecting sheet,
wherein a position of the receiving bag corresponding to at least the information indicating part is formed to be transparent or translucent.

83. An envelope with a personal information protecting sheet, comprising:
a personal information protecting sheet according to claim 22; and
a receiving bag for receiving the personal information protecting sheet,
wherein a position of the receiving bag corresponding to at least the information indicating part is formed to be transparent or translucent.
